(19) United States
(12) Patent Application Publication
(10) Pub. No.: US 2021/0097473 A1
(43) Pub. Date: Apr. 1, 2021

(54) Mobile scheduling system

(71) Applicant: James Kirunda Kakaire, Silver Spring, MD (US)

(72) Inventor: James Kirunda Kakaire, Silver Spring, MD (US)

(21) Appl. No.: 16/873,659

(22) Filed: Dec. 23, 2018

(51) Int. Cl. G06Q 10/06

(52) U.S. Cl. CPC G06Q 10/063114; H04W 88/02; G06Q 10/063116

(57) ABSTRACT

A worker scheduling system that solves the problem of fluctuating work schedules and provide schedules on a mobile app. Employers and workers have a web based interface to the scheduler. Instantaneous changes to a schedule are reflected to a worker's mobile device with an alert. The system provides an automated worker schedule based on available resources if no human intervention comes in. It automatically assigns vehicles and equipment. User Settings are provided to restrict schedule display options which include individual schedule, by project, by supervisor or all workers. The scheduler taps into the worker's availability calendar to provide daily, weekly, monthly or annual schedules. The customizable scheduler provides aiding tools to workers based on their company activities. Second and third party clients enter work projects providing parameters that include number of employees required, required skills, start date, start time, end time and job duration utilized during auto scheduling.

The Mobile Scheduling System in this application refers to a worker scheduling system that is a Mobile App with manual and automated scheduling. The system also provides a web based application accessible through a website. It claims priority of provisional application No. 62/610,169 filed Dec. 23, 2017 titled Mobile Scheduling System.

### BACKGROUND OF THE INVENTION

### Field of Endeavor

It is a software based system that is downloadable as a Mobile App and also accessible as a web based application through a website. It simplifies the process of scheduling workers with fluctuating schedules.

The scheduler software system also known as Scheduler App solves problems of fluctuating work schedules that change frequently. It provides short term and long term schedules. That is, daily, weekly, monthly, quarterly, semi-annual and annual schedules. It supports applications that accomplish tasks including record keeping, real time distributed data entry for projects on the go such as those from moving companies, employee time off request directly into a time management software system, inventory processing and streamlining of medical data collection. Utilizing this data and worker pre-existing data, the scheduler system automatically generates schedules. Supervisors access time off requests and approve or deny via the mobile app.

Though the Secure Scheduling System does all schedules, it specializes in fluctuating schedules. Instantaneous changes on a schedule are reflected on the user's mobile device in real time. When there is a change in a schedule, alerts are sent to those that are affected to check the schedule.

The design is independent of hardware, operating system or software development technologies. For the most part, the software system is data driven with a database or files in the backend. The software can be developed utilizing cross platform hybrid technologies such as JavaScript, CSS, HTML for the front end and a server side technology in which SQL is embedded to accessing the database or files. Alternatively, frameworks, native technologies such as Java for Android, C-Shop for Iphone and others can be utilized in conjunction with the database.

The system has a mobile interface and a computer based interface both of which interact with the data on the server to provide information to the users. All access to data is by authentication though one can save the password to ease the login process. If a user has no mobile app on their device, they can log onto the service website and access the schedule and other information.

Employers posts schedules via the mobile app or website from a large screen such as that of a computer by authentication. Workers access their schedules through the mobile app or by logging into the website with a user id and password.

Office based users enters data via their computer into the data storage on the server and the mobile application retrieves the data and displays to the user as necessary. Similarly, mobile users do real time data entry that goes to the server and get viewed by any of the authorized personnel regardless of whether they have mobile devices or office based computers.

Announcements are submitted by authorized personnel utilizing a user interface with a text area without seeing any coding. The announcements can be textual, images or videos. When empty, the announcement slots collapse giving more room for other parts to display. Announcement headings are highlighted differently for emphasis. However, headings are optional. At least one announcement window displays ads in form of videos, text or audio in a designated window separate from other content of the mobile app display. The ad display window is utilized in various apps including job apps, religious apps, forums apps, property management apps and time fixing apps.

The software system provides other features such as built in phone call and navigation. It works with independent applications including the calendar and a communication module. Upon launching the application, it displays a menu corresponding to user type as seen in figure titled dispatch in a 3 dimensional transparent text. The system is customizable to company needs.

Employees are provided with a text field or text area in which they type and submit text as suggestions to the company. That is, if employees have a better way of doing something, they let management know and this is visible to many people in the company who can expand on it.

The application displays tabs on top for showing days of the week in two different ways as shown in FIG. 24. A total of seven tabs each showing days of the week Monday as (Mon), Tuesday as (Tue), Wednesday as (Wed), Thursday as (Thu), Friday as (Fri), Saturday as (Sat) and Sunday as (Sun). In one implementation, each day that passes breaks off or hides and the following day starts the trend until it is the last day Sun then it starts over.

In another implementation of FIG. 24 (b), all the seven days shows all the time but the current one is highlighted by default. A day of the week and date displays as read from the system.

Automated announcements fields are dynamically generated based on the announcements that are to be posted. The content expands with quantity of text. If only one announcement is posted, the other fields collapse. The application can provide as many announcements as the customer may want. Content and title are typed in two different text areas or text fields.

Below the announcements is the schedule. The schedule is displayed in two different ways. In one implementation, the schedule is grouped by employees that start at the same time. Start time and approximate end times are displayed on top before the names in each group. When a name is showed, a number is displayed first followed by the name and start time then a comment specific to that employee.

The scheduler interacts with the personal calendar application and reads the employee's availability information before finalizing the schedule for a project or routine work. The scheduling person does minimum schedule editing whenever necessary. In addition, the system computes hours worked for every project and automatically upload them to the payroll records after supervisor approval from the mobile app or browser based app saving hours of data entry to the server. The Scheduling System reads worker availability, accumulated time, skills and conditions to automate the scheduling wherein schedules are visible in the installable mobile app without human intervention. An entity is dedicated to store conditions with several attributes that include available times, work authorization, criminal history, clearance, limitations and more. Employees also access the schedules via web browsers from any device.

In another implementation, the schedule is only sorted by start time and displayed in order of start time. No groupings are involved. In such a case, start time is displayed alongside each scheduled employee and comments if any.

Users view individual schedules, view project based schedules, by supervisor or companywide schedules visible to all workers. This depends on company policy. That is, the software system is customizable to fit policies of any company or industry whose schedule fluctuates. User Settings are provided to restrict schedule display options.

The schedule is then followed by links at the bottom that may be in form of buttons as showed in FIG. 24. A settings button is also provided to allow users to configure appearance of the application on their device.

In this application and all other applications we develop, the application tests for screen size (phone, tablet or computer) and provide a corresponding user interface.

Mobile App Version Control:

A variable is declared to store the application version. This variable may exist as a variable within the code, in a local file or on a resident mini database. When a new version of the application comes up, the application reads the version in the variable and compares it to the new version. If the version is older, the user is prompted to update their app. Alternatively, the application automatically updates the app.

In another implementation, the application stores the user's app version along with the login data in the database. When a new version of the app comes up, the user is periodically informed to update. The application can as well update the mobile up user's app automatically. Under both implementations, the server side application can prevent a user from authenticating if they have an old version of the mobile app.

### BRIEF SUMMARY OF THE INVENTION

A Secure scheduling system that provides daily, weekly, monthly and annual worker schedules via a Mobile App accessible by authentication. It generates schedules for medical workers, movers, restaurants, food workers, factory workers, warehouses and retail workers. Other industries are by customization. The scheduler utilizes real time distributed data entry to automatically generate schedules. Employees request for time off via a mobile app and sends requests directly into a time management software system from which supervisors approve or deny the requests. It reads worker availability; accumulated time and skills records to automate and avail the schedules on the mobile app. Instantaneous changes on a schedule are reflected on the user's mobile device in real time. The system provides dispatchers with touch or click options to display employee schedules for single employee, by project, by supervisor, by department or all employees at once. It displays ads in form of videos, text or audio in a designated window separate from other content for medical workers, movers, restaurant workers, food workers, warehouse workers, factory workers and retail workers. Other types of users get customized displays.

### BRIEF DESCRIPTION OF THE VIEWS OF THE DRAWINGS

FIG. 1 Is an interface with login text fields, a submit button, a create worker account button and a create employer account button which displays an interface that invokes an algorithm to save data to the database.

FIG. 2 Is the algorithm that takes company code and facility code and query a database system on a server to generate schedules for authenticated workers based on data. It populates a data structure with scheduled records to format and display on user mobile phones or website.

FIG. 3 Is an algorithm that formats the displayed schedule based on employer display options. Select schedule display options displays an interface for setting schedule display options. Algorithm reads the database from server memory and loads formatting parameters to data structure to style and display the schedule on mobile devices and website.

FIG. 4 Is the algorithm that adds patients from the receiving server to the software system.

FIG. 5: The algorithm that adds projects to the software system. When an employer has no account (11), they create account by entering their name, email, phone number and company info including employer identification number. They save a project to be worked on and schedule the project to synchronize with the production server for employees to view.

FIG. 6: The algorithm that submits queries to a database in server memory to read worker availability including time off requests, skills, employee calendar, hours worked to date, maximum and minimum hours a title can work and conditions; and schedule the employees. It saves the schedule to database in server memory to avail it for employees to access via mobile devices. Algorithm advise management to post announcement for extra time available when some positions are not covered.

FIG. 7: The algorithm that authenticates users to display a home page of a mobile scheduling system based on user title. It takes email or phone number and password through an interface When authenticated, the algorithm extracts ads from the database entity tblAnnouncement on server and displays them in form of text, video or audio in a designated mobile scheduler window on a mobile phone as shown in FIGS. 21,22 and others.

FIG. 8: Is the algorithm that displays the current tab in a group schedule and ads or announcements. The algorithm extracts ads from the database entity tblAnnouncements on server and displays them in form of text, video or audio in a designated mobile scheduler window on a mobile phone.

FIG. 9: Algorithm that adds patients to the system from the data source server.

FIG. 10: Is the algorithm that tracks employee hours worked, records day start and end time from a computer or mobile device and calculate net hours worked saving to database in server memory. It provides for editing hours worked and exports hours to payroll records to facilitate check payments. Supervisor or client edits hours when not agreed on. Authenticated users view hours worked and hours to date from mobile phone app utilizing button links and from the website.

FIG. 11: Is the algorithm that uploads employee hours from scheduler to payroll database in server memory. The algorithm exports hours worked and total hours to payroll records to facilitate check payments. It also exports one project at a time. The system computes hours worked for every project and automatically upload them to the payroll records after supervisor approval from the mobile app or browser based app.

FIG. 12: Is the algorithm for processing medical patients.

FIG. 13: Is the algorithm that submits queries to the database in server memory to process time off requests. Algorithm records company holidays and accumulated hours; and utilize them when displaying time off on user mobile devices. A request invokes algorithm to execute an insert query and save request to database in server memory. Manager is auto alerted to process the time off request. Approved time is reflected on employee calendar and app on mobile phone. It is also viewable from the website. Employee authorizes calendar access which displays holidays.

FIG. 14: The entity relationship model for the scheduler database (E-R Model) contains several entities including.

FIG. 15: Is the medical activity entity relationship model. The entities tblCustomers, tblUsers and tblEmployees contain the attributes firstName, LastName, email and phone that are embedded in a user interface. Authenticated users change their phone number and email in the mobile scheduling system.

FIG. 16: Is the general chores entity relationship model (E-R Model).

FIG. 17: Is the scheduler database schema with multiple entities and their attributes saved to memory on server. The entity tblAuthentication with the attributes userid, email, phone, password, companyCode, facilityCode and title for creating user accounts and authenticating mobile scheduler users by title or user type. Employers provide employer identification number to complete account creation for the mobile scheduler. The system generates a unique id that employers provide to employees to create mobile scheduler accounts that employer approves before use. The id may include companyCode, facilityCode and a user code. The entity tbISchedule with attributes customerld, employeeld, projectNumber, schedule Date, startTime, endTime is utilized with companyCode and facilityCode to display the schedule. TblAnnouncements with attributes announcementld, announcementSlot, authorid, authorType, announcement Date, heading and content stores and displays ads on mobile phones. Interfaces with button links invoke algorithms to write data to databases in server memory and display it on mobile devices.

FIG. 18: is the medical and other database schemas in server memory. The entity tblDisplayOptions with the attributes optioned, employeeld, nameFormat, shiftDisplayStyle, timeDisplayStyle, scheduleChangeTime, num DaysScheduled, scheduleDisplayLength and colorHighlight saves data that controls how names, shift and time are displayed. It also controls when a schedule is changed, number of days scheduled at a time and schedule length such as week, month, quarter or four months.

FIG. 19 Is a user interface for a group schedule accessible by authentication on a mobile device such as a mobile phone or tablet. It displays announcements and ads in form of text, video and audio.

FIG. 20 like FIG. 19 interface that provides Job Details, Inventory, Hours to Date, Messaging, My Calendar and Time Request buttons to execute algorithms that connect to the database to read and process data saving to memory on server.

FIG. 21 the algorithm that authenticates users to display a home page of a mobile scheduling system based on user type, displays the mobile phone interface of FIG. 21. It provides buttons to schedule employees, set schedule display options, post announcements, post extra time available, process time off requests, add new or edit project and more. Employers process time off requests via a button link that invokes algorithms to read and save data to database in server memory.

FIG. 22: the algorithm that authenticates users to display a home page of a mobile scheduling system based on user type, displays the mobile phone interface of FIG. 22. It provides buttons for viewing group schedule, personal schedule, extra time available and more. Employees request for time off via the time request button link which invokes an algorithm to execute an insert query and save request to database in server memory.

FIG. 23 is the interface that displays when an employer opens the Schedule Display Options of FIG. 21 from a mobile phone or website. The interface provides date selection options, check buttons, radio buttons and dropdown menus to format a schedule and save to database in memory. Formatting determines whether a schedule displays for a day, weekly, monthly, by range or year on a user mobile device.

FIG. 24 Is the interface displayed on a computer to schedule employees after opening the Schedule Employees button on FIG. 21. Current Hours indicates hours worked to date for each employee. Bold and Highlight formats the displayed schedule. The mobile version is vertical.

FIG. 25 interface displays when an employer opens Post Announcements button on FIG. 21. The interface that provides optional heading, a text area for posting announcements, selection of date to be posted, file attachment for video files not shown and importance level or priority indicator selection for authorized users to post announcements or ads. The submit button saves the announcements or ads to the database on server memory.

FIG. 26 is an interface for employers to post extra time available with options to select date of extra time, start time and job duration with a text area that describes duties. It displays when an employer opens Post Extra Time button FIG. 21. The submit button link invokes an algorithm to save data to the database in server memory and saved data auto displays in a designated window of the mobile scheduling app on a mobile phone. Alternatively, employee presses a button link labeled Etract Time Available.

FIG. 27 displays when an employer opens Add New Employee button FIG. 21.

FIG. 28 displays on opening Process Time Off Requests button on FIG. 21. The interface comes with button links from where user approves all applicants, approve individual, deny, send message to applicant, view employees on vacation and view scheduled time off. Arranges requests by seniority and request order. User sets a reminder from a dropdown menu to delay and process later.

FIG. 29 displays on opening Add New Project or Edit Project FIG. 21

FIG. 30 is utilized on a computer or mobile phone to assign employees and equipment to a project.

FIG. 31 the algorithm that authenticates users to display a home page of a mobile scheduling system based on user type, displays the interface of FIG. 31 for a supervisor menu on a mobile phone to process data based button links as shown on the interface. The extra time available button link displays an interface for posting extra time available viewable from worker mobile phones. Button links invokes algorithms to process data and save to database in server memory.

FIG. 32 the algorithm that authenticates users to display a home page of a mobile scheduling system based on user type, displays the mobile phone interface of FIG. 32 that provides individual schedule of a worker on a mobile phone one week, or month at a time to a year based on schedule display options set by employer in the database in server memory. The partial annual calendar automatically displays months on top or side though months are also manually moved.

FIG. 33 displays a monthly group schedule on a computer screen.

FIG. 34 the algorithm that authenticates users to display a home page of a mobile scheduling system based on user type, displays the mobile phone interface of FIG. 34 that provides a weekly group schedule on a mobile phone showing start time and end time. Name and corresponding start time are displayed on one line followed by a targeted message if needed. The interface displays announcements in form of text, video or audio ads that are extracted from database in server memory.

FIG. 35 displays a month long schedule on a mobile phone. Months are automatically displayed though do scroll manually.

FIG. 36 is an interface utilized to take equipment inventory out of a warehouse.

FIG. 37 is an interface utilized to return equipment inventory to a warehouse.

FIG. 38 opening the button link “Extra Time Available” on FIG. 22 or FIG. 39 displays a mobile app interface that shows extra time available with a button link labeled I am In for employees to apply. Hitting the mobile app button link on a mobile phone invokes an algorithm to submit the overtime request to the database in server memory to apply for the overtime.

FIG. 39 is a medical staff interface for schedules, announcements and more as indicated by the button links that invokes algorithms to interact with database in server memory.

FIG. 40 the button link labeled Edit Time Sheet on FIG. 31 displays the interface of FIG. 40 on a computer to edit time entries. The interface is vertically displayed on a mobile phone. The button link labeled accept time as is, all records time as displayed and the button link labeled edit one to apply to all edits one worker hours and records results for all workers involved saving data to database in server memory.

FIG. 41 is an interface with button links that invokes an algorithm to track employee hours worked, approve prerecorded end time or edit the end time from a computer or tablet and save to the database in server memory. The mobile phone version is vertically rendered. The interface records time at end of day.

FIG. 42 displays individual schedule on a computer or tablet screen.

FIG. 43 the algorithm that authenticates users to display a home page of a mobile scheduling system based on user type, displays the interface of FIG. 43 for a worker menu on a mobile phone. It extracts data from the database and displays information required to perform the current job including company name, address, contact person, contact phone numbers and more.

FIG. 44 is an interface that invokes algorithms to read data from database in server memory and embeds it into button links of the mobile app generating a listing of employee names and phone numbers. Authenticated users change their phone numbers and email in the scheduling system database in server memory to reflect current contacts.

FIG. 45 a mobile phone interface that reads emergency contacts related to a job in progress from database in server memory and embed the contacts in button links. A button press on the mobile phone app calls the worker names listed against the button.

FIG. 46 interface that displays hours worked for a day on a mobile phone. A button edits hours which are approved by supervisor from the supervisor menu. The button labeled view hours to date displays unpaid hours to date per project.

FIG. 47 The mobile phone interface displays hours worked for every project worked on showing start time, end time and breaks. The supervisor button displays supervisor name and contact. A button creates a pdf file and another button prints out the hours.

FIG. 48 The mobile phone interface of FIG. 48 invokes an algorithm to submit time off request data to database in server memory. It provides data entry fields for stat date and time of time off and end date and end time of time off. It provides options to choose type of time requested including vacation and sick leave. The interface invokes algorithm to save data to database in server memory.

FIG. 49 The mobile phone interface of FIG. 49 provides a warehouse menu on the mobile scheduling system that interacts with algorithms for users to view announcements or ads in form of video, audio or text, view group schedules, view individual schedules, edit time sheet, view equipment inventory, give out equipment, accept returning equipment and more as indicated by the buttons. The accept returning equipment button invokes algorithm to save data to database in server memory.

FIG. 50 the interface of FIG. 50 on a mobile phone or computer interacts with algorithms to record equipment inventory given out. Quantity of each type is prefilled and confirmed by press of a button link then saved to database in server memory.

FIG. 51 the interface of FIG. 51 on a mobile phone or computer interact with algorithms to record equipment inventory returning from the field. Type and quantity are prefilled in and confirmed by button links or edited in text fields and saved to database in server memory.

FIG. 52 the interface utilized by warehouse manager on a mobile phone or computer invokes algorithms to perform functions as displayed by the button links. Each button link displays a new interface that reads data from database in server memory, processes the data and saves accordingly. The manager confirms start time, edits time sheet, confirms finish time, enters new equipment, gives out equipment, accepts returning equipment and more. Interface is utilized by any manager as needed.

FIG. 53 The payroll interface that invokes an algorithm to upload employee hours from the mobile scheduling system to the payroll database in server memory to facilitate check payments. Though the system is automated to transfer data from scheduler to the payroll database, payroll users utilize button links to transfer data and accept all projects at once, accept one project at a time, preview project data before uploading, obtain older schedules to reconcile hours worked and more. The reserve button edits timesheet or hours, edits paycheck and more.

FIG. 54 The interface invokes algorithms that records new projects, display project status, approve timesheet, make a payment and more. It is utilized by authenticated customers.

FIG. 55 the algorithm that authenticates users to display a home page of a mobile scheduling system based on user type, displays the interface of FIG. 55 for a general manager menu on a mobile phone, tablet or computer. The general manager or need to know user accesses the dispatch menu, supervisor menu, employee menu, warehouse menu, payroll menu and customer menu as needed. All menus utilize messaging and calendar modules.

FIG. 56 The interface that provides a settings tab for configuring app usage on a mobile device. This includes setting how many cases or patients to display at a time, frequency of alerts in minutes, last reminder frequency and alert type.

FIG. 57 the algorithm that authenticates users to display a home page of a mobile scheduling system based on user type, displays the interface of FIG. 57 for a supervisor menu on a mobile phone, tablet or computer. The supervisor schedules employees, sets schedule display options, views group schedules, posts announcements that are viewed by all employees from a designated section of the app screen, post extra time or overtime available, add employee to the mobile scheduling system or edit them, process time off requests and more. The interface is utilized by supervisors from any industry. Other functions are conducted as shown on button links.

FIG. 58 this interface with button links invokes an algorithm that tracks employee hours worked, start clock to record start time and edit start time from a computer or tablet to save to the database in server memory. The mobile phone version is vertically rendered. A manager adds a worker manually when the worker is not on the list of scheduled workers. The start clock button starts time for one worker and start clock for all workers button starts time for all workers at the same time. Edit start time edits time for a worker and edit start time for all workers sets start time to be the same for all workers. Authenticated users view hours worked and hours to date from mobile phone app utilizing button links and from a website.

FIG. 59 the algorithm that authenticates users to display a home page of a mobile scheduling system based on user type, displays the interface of FIG. 39 for the medical staff and nurses with a job details button link. The job details button invokes algorithms to display the interface of FIG. 59 that extracts data from a database in server memory and shows patient case load for the medical worker including patient Id, floor, room, bed, next service time and instructions on a mobile phone or tablet.

FIG. 60 The case details button tab on the interface invokes an algorithm that fetches data from a database in server memory and displays detailed information about each patient. The medical staff or nurse presses a status button when finished with a patient and the button changes color to indicate the patient is seen and data saves to database in server memory for all staff to see mobile devices and computers.

### DETAILED DESCRIPTION OF THE MAIN EMBODIMENT

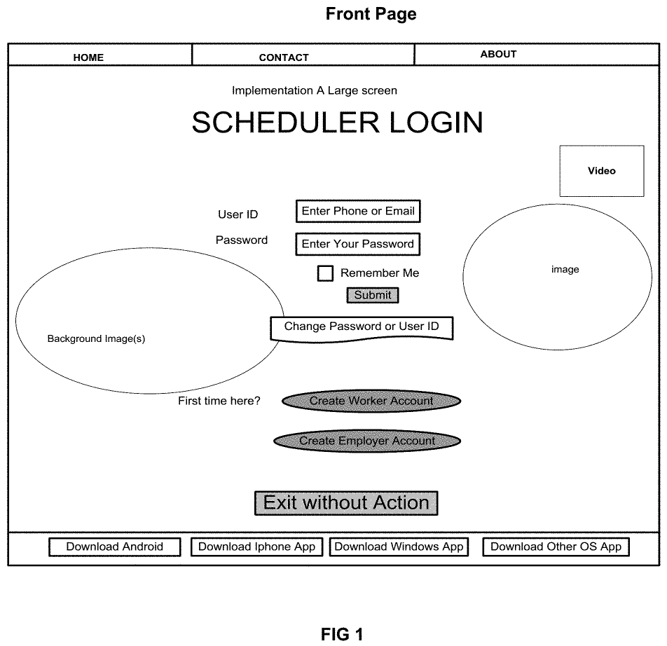

FIG. 1 is the authentication user interface on a mobile phone or computer.

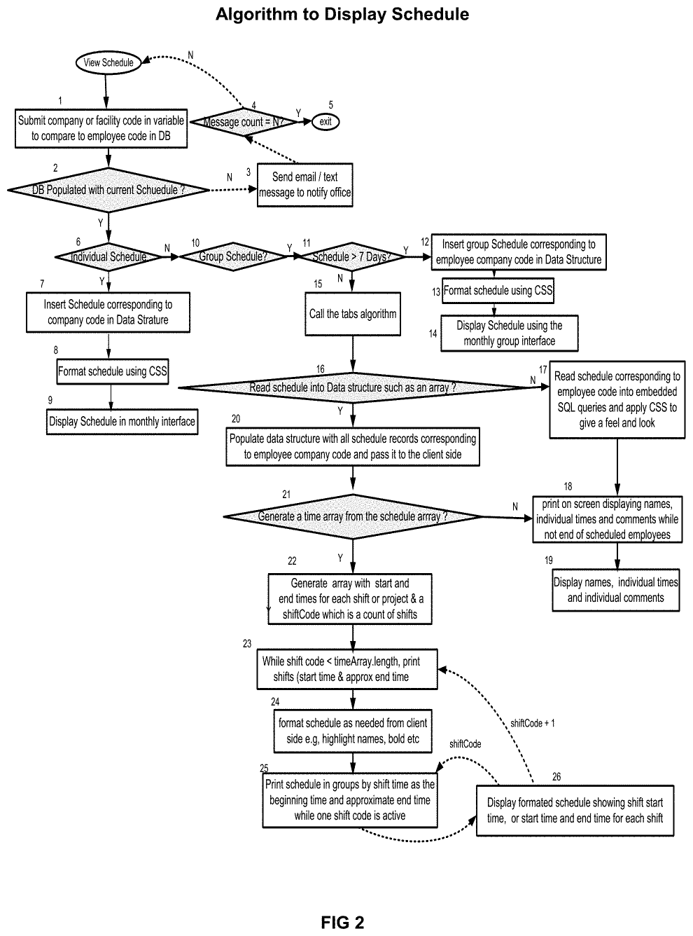

FIG. 2 is the algorithm that displays the schedule. The data structure that carries the schedule from the database or file system to the client side includes but not limited to user ID, first name, last name, middle initial, time scheduled, comment, highlight color, bold message and the schedule Change Time attribute. This data structure could be an array, array list or other.

To display a schedule, a graphical user interface with a selection menu is displayed first providing buttons for displaying an individual or group schedule.

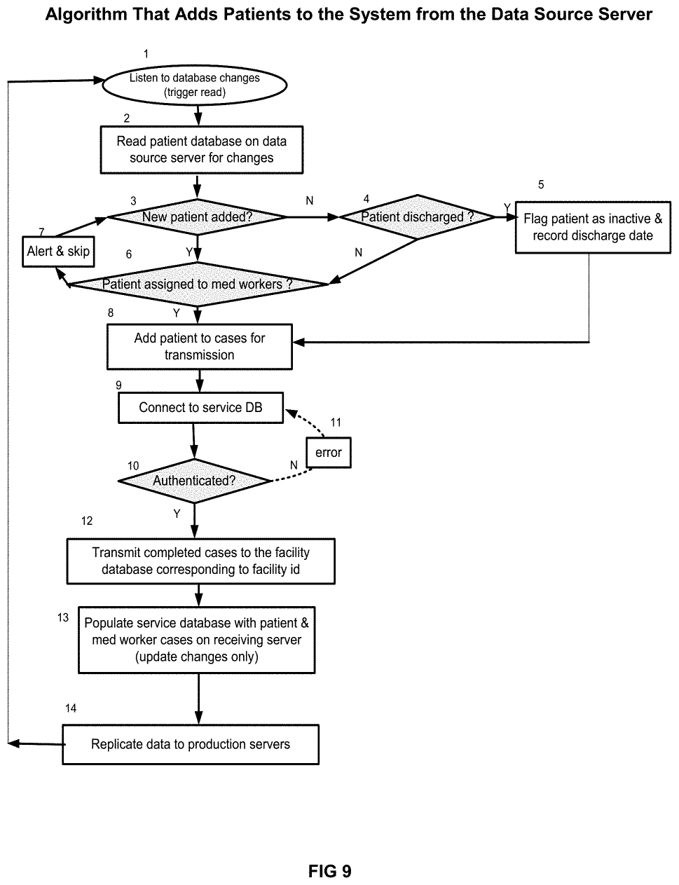

The display schedule algorithm of FIG. 9, starts by submitting a company or facility code obtained at logon 1. This code prepares the application to select a schedule related to the company or facility code only. The same code in conjunction with the user id is utilized to access other information such as patient records for a healthcare facility. If the current schedule (day and time a schedule is supposed to be up) is not manually approved in the database 2, the application sends email or text message periodically to the office to notify them that the current schedule is not finalized 3. Before sending the message, it checks the counter 4, to make sure it is not sending a message more that the specified number of times N. When the counter reaches the specified number N which could be 2, 3, . . . N, it stops sending 5. After a preset time, the schedule is posted as is without manual intervention.

If the current schedule is available in the database 2, the application checks to see if the request is an individual schedule 6 or a group schedule 10. If it is an individual schedule 7, the schedule corresponding to the employee company code is inserted into a data structure and formatted using CSS and a scripting language such as JavaScript 8 for appearance and behavior respectively. The schedule is then displayed 9 on a miniature interface for small screen or on a twelve month interface for large screens. Both these interfaces are presented ahead.

If the view schedule request is for a group schedule 10, the algorithm checks to see if the schedule is longer than seven days 11. If it is longer than seven days, the schedule corresponding to the employee company code is placed in a data structure such as array or array list 12 and formatted using CSS and a scripting language such as JavaScript 13. The schedule is then displayed utilizing the monthly group interface for large screen which shows all twelve tabs one for each month or an interface for a small screen that shows only 3 to 4 month tabs at a time 14.

If the group schedule is only seven or fewer days long 11, the algorithm calls another algorithm specifically for displaying the days tabs on top of the interface 15.

The application then checks the method of choice to display the schedule 16. If the method of choice is not populating a data structure with schedule records, the application which utilizes embedded SQL queries reads the schedule corresponding to the employee code from the database and if necessary styles it using cascade style sheet for a look and feel 17. The app then displays the schedule for each record on the screen 18. The application continue to read the schedule from the database while it is not end of records 19 and displays it in a tabular form showing name, individual time scheduled and any individual comment.

If the method of choice is loading the schedule into a data structure such as an array or array list 20, all schedule records corresponding to the employee company code are read once into the data structure and passed onto the client side app for manipulation. Alternatively, each record is read into a one dimensional array (1D) and each of the 1D array is loaded into a two dimensional array (2D). The one dimensional arrays may be named at run time using a variable that identifies the 1D arrays in the database such as userID or simply using one name for all 1D arrays and pushing them one at a time onto the 2D array as they are populated with data.

The variables contained in the schedule array such as highlight Color, bold, schedule Change Time etc are utilized with CSS or and JavaScript to change the look of the names as desired by the scheduling person via the supplied appearance parameters (bold, color highlight, schedule Change Time etc).

If another array is needed for storing only start time, end time and another variable such as shift code 21, a time array is extracted from the schedule array and two arrays are now available to the client side application 22. Data in the time array is extracted from the employee scheduled array possibly named scheduledEmployeeArray or otherwise.

The shift code in the timeArray is a count of the number of times; different start times occur. If employees are scheduled at 7:00 am, 7:30 am, 9:00 am and 11:00 am, the shift code is the count of these different times which is equivalent to four. The timesArray length becomes 4 in this case. Hence timesArray.length=4. This enables the printing of start time and approximate end time 23 for each shift on top of the shift names using the external loop and printing the names under the start and end times using the internal loop.

The schedule is formatted accordingly. Each record is printed out as it is modified 24. Here the start time and end time are provided for each group or shift of employees as displayed in some of the user interfaces.

For each shift code in the time array, a group of names is printed utilizing an internal loop represented by parts 25 and 26. When the records corresponding to a shift code are depleted from the array 26, shift code is incremented by 1 and loops again for new records all displayed in groups preceded with start time and approximate end time. Any record alterations are carried out here from the data structures on the client side.

The source code for printing out the names may look similar to:

```
For (shiftCode = 0; shiftCode < timeArray.length; shiftCode ++){
  Print start time and approximate end time
  For (index = 0; index < scheduledEmployeeArray.length; index ++){
  If (timeArray[shiftCode][startTime] ==
scheduledEmployeeArray[index][startTime]){
    Print name formatted as desired, individual time and comments
  }
  }
}
```

This code converts to other kinds of loops such as while, do while, repeat until etc depending on programmer choice.

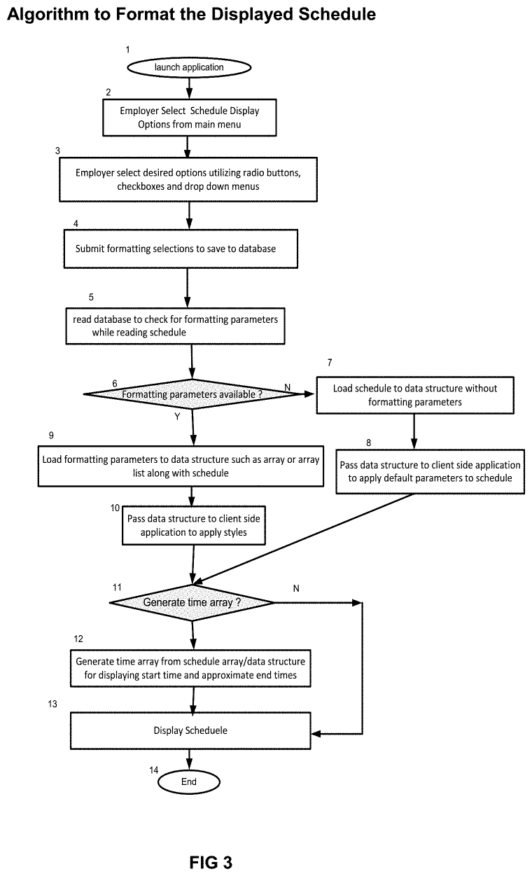

FIG. 3 the algorithm of FIG. 9 (b) allows the program to display the schedule with or without specific formatting. When the employer or dispatcher launches the app 1, It provides a user interface from which the schedule is styled and displayed based on name format, shift display, time display or length of schedule. They select Schedule Display Options from the menu 2 and choose the desired formatting by utilizing radio buttons, checkboxes or dropdown menus 3 to accomplish the tasks. When they hit submit at the UI, the formatting options are saved to the database 4. To display the schedule, the application reads the database 5 to check for formatting parameters along with the current schedule. If no formatting parameters are available at step 6, the application loads the schedule to a data structure such as array or array list without formatting parameters 7 and pass the data structure to the client side application to apply default formatting 8. If new formatting parameters are available at step 6, the application loads the schedule to a data structure such as an array or array list along with the formatting parameters 9 and pass the data structure to the client side application to apply the styles using CSS, Bootstrap or other styling technology 10.

If the client desire the application to display start time and approximate end time for each project group, the application checks to see if a time array is desired 11. If the time array is not desired, the application displays the schedule showing only time that shows besides names 13. If the time array is desired, the application generates the time array from the schedule data structure or schedule array 12 and utilize it to display start and end times for each project as a group 13. The application then exists 14.

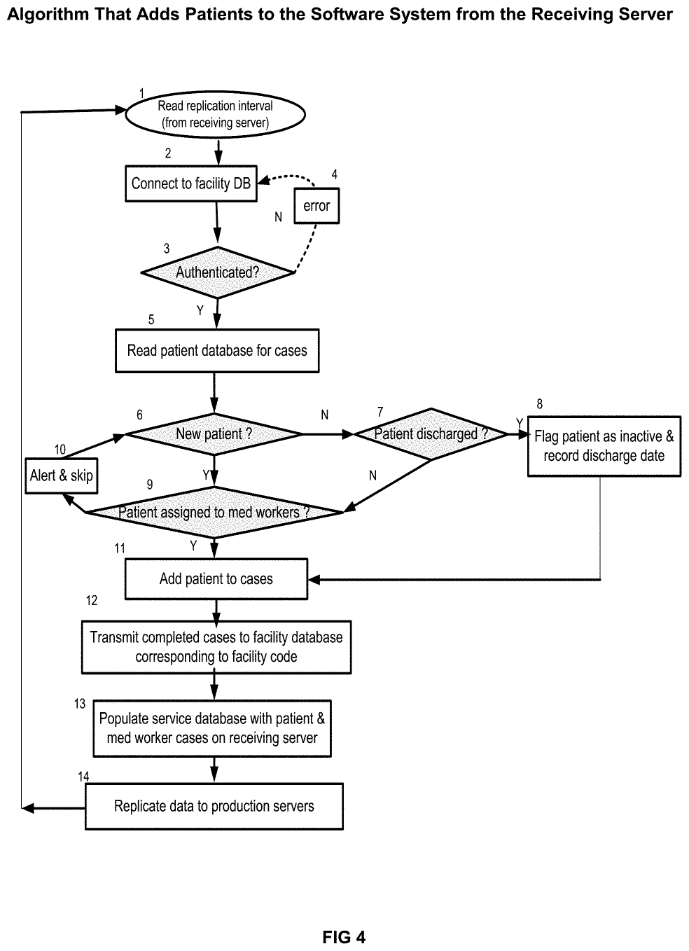

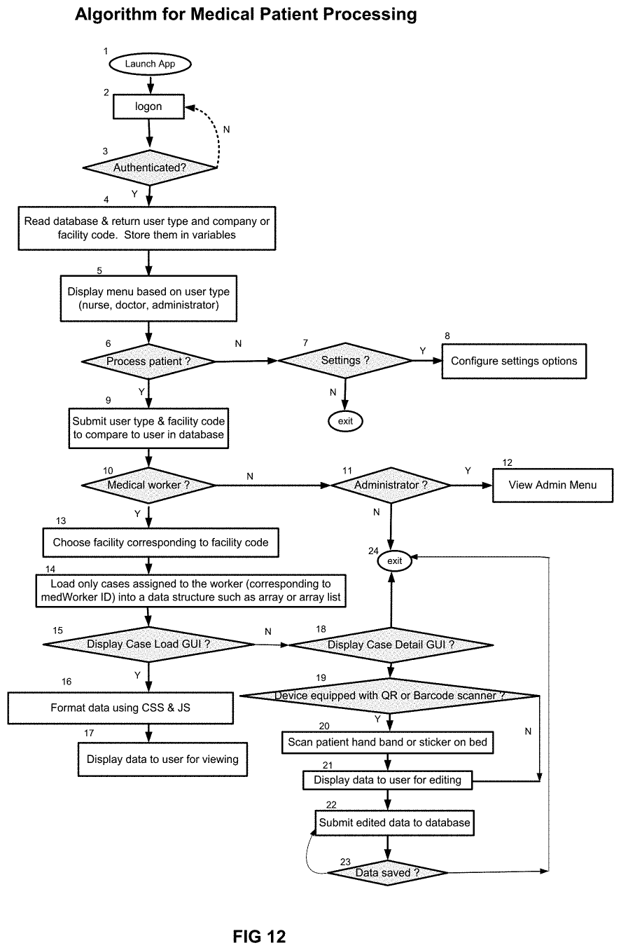

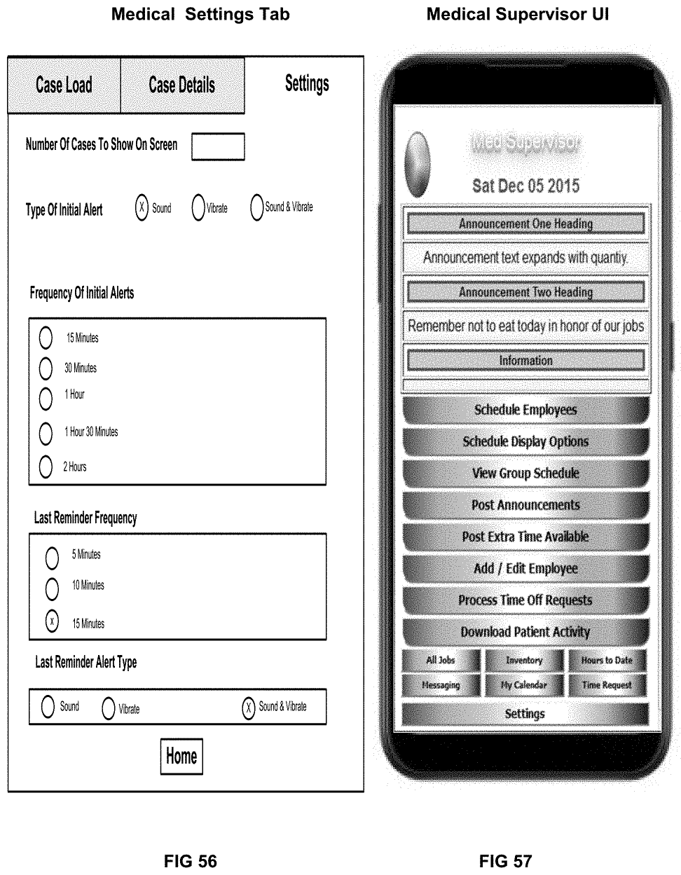

FIG. 4 In addition to the algorithm of FIG. 12 that processes a patient in the medical module, two other algorithms were designed both to add patients to the Software System. One in FIG. 56 is loaded on the data receiving server. A data replication interval is set to time t where t equals 30 minutes, an hour or some other value. The algorithm reads the set interval 1, and connects to the database server when the interval time matches 2. If not authenticated at 3, it keeps trying for a number of pre-set times and finally gives an error message 4.

If authenticated at 3, the algorithm reads the patient database on the origin server traversing through all records 5 looking for new additions 6 and existing patients 7. If existing patients are discharged 8, the patient is flagged as discharged and the discharge date is noted prior to transmission 8. The patient is now added to the case load to be transmitted to the receiving server 11. Triggers are also utilized to replicate every transaction in real time.

If the patient at stage 6 is a new addition, the application software checks to see if the patient is assigned to medical workers such as doctors and nurses 9. If no medical workers assigned, the application software alerts the medical stuff by placing a visible icon with a yellow or red color that may even flash for attention 10. The patient that is not assigned medical workers is skipped until attended to. After all assigned patients are added 12, data transmission takes place to a database identified by the facility code involved.

The transmitted data populates the database on the receiving server with cases where patients are assigned to medical workers and their respective details 13. Data is then replicated to the production server 14. If however, one server is utilized as the receiving and production server, replication is not necessary in that case.

However, in another implementation, a trigger is set instead of a set interval. The trigger listens to changes in the data entry and replicates immediately. It replicates additions and deletions or discharges. That way, all schedules are always current to the minute.

The machine placed at the client's site may be populated with details such as patient's names and medical worker names but incoming data populates the remaining fields. The application auto synchronizes the data. This is a security feature to prevent passing identifying information over public networks. Diagnosis, medications and patients are linked by patient ID number not name.

FIG. 5: The algorithm of FIG. 5 adds projects to the software system, the scheduler. When the application is launched 1, it checks for screen size. If it's a mobile small screen 2, a user interface for small screens 3, is provided to the user. If it is a large screen such as that of a laptop or desktop computer 4, a corresponding large screen user interface 5 is provided. If the screen is that of a tablet device 6, a tablet size user interface is displayed 7. If not recognized, the application exists 8.

With the user interface at hand, the application provides three options. If the user has an account 9, they logon 10. If they are interested in creating an account 11, they create one 12. If the user is not interested in creating an account but want to post a project for an estimate or for other reasons 13, they fill the provided form and submit it. Submission of data with user info generates a partial account 14. When the user becomes a customer, they are provided with their partial account to complete 15 next time around.

When a user logs on to add a project 10, they are provided with a form with most of their information pre-filled 16. They only fill in a few remaining items and submits 17. Based on user ID and user type, the application determines if it is not the client 18 submitting the entry and it is not the company owner (employer) 19 and it exists 20. If it happens to be the employer 19, the project is saved and labeled ready for execution 23. If entry is from the client 18, the application checks to see if a project estimate 21 is provided. If not 22, it sends alert to the office to provide estimate.

If the project estimate is already provided and accepted 21, the project is saved and flagged as ready for scheduling and execution 23. During the scheduling, number of employees and necessary equipment are assigned 24. The software system now categorizes the projects 25 based on execution dates, start time, end time, required skills and employee availability. Entries come from selection menus to minimize data entry errors. The project is scheduled upon submission of the entries 26.

When necessary, the employer does minor schedule edits which mounts to addition, removal or replacement of individual(s) from the schedule.

Depending on configurations under settings, the employer may choose to automatically synchronize the schedule 27 or manually synchronize it with the production server (placing it in a production state) 28. Once in production, the schedule and jobs are viewable by employees. If on the other hand a manual setting is in place and time for uploading the schedule is past due, the application sends alerts to selected people. If the option for overriding a delayed production is checked, the application overrides the manual setting after a set time period such as one hour and posts the schedule.

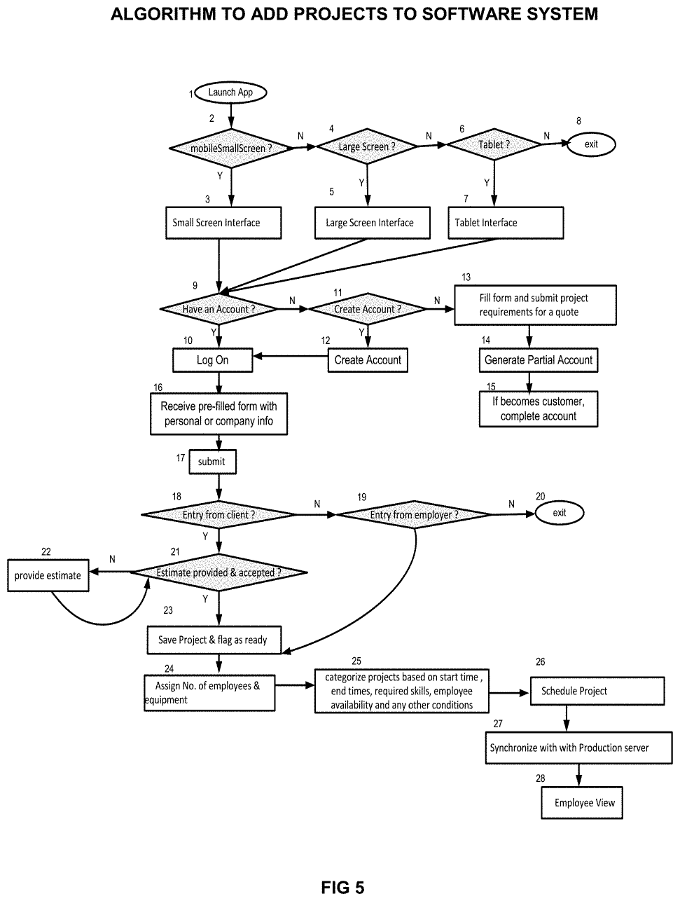

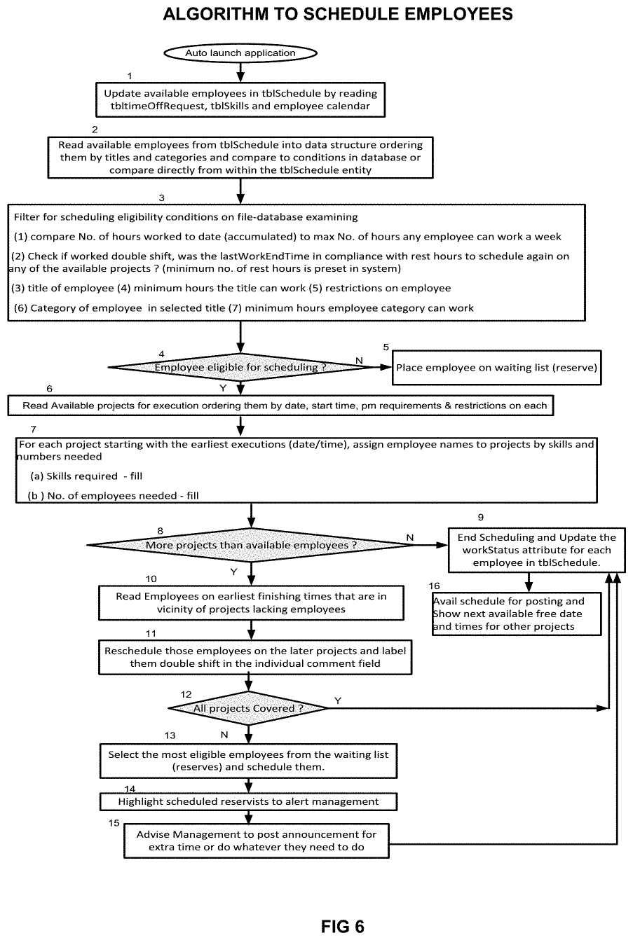

FIG. 6 the algorithm of FIG. 6 enables a program to automatically schedule employees to work on a project or job. It is invoked by the algorithm of FIG. 5 which adds projects to the software system. However, it can be executed manually. When the software application is invoked or executed 1, it reads the approved time off request from the entity tbltimeOffRequest and updates the workStatus attribute in the entity tblSchedule to offDuty. It also reads the entity tblHasRequiredSkills for the needed skills and list the skills for each employee. If allowed by the user, the application also reads the user's (employee) calendar to update the workStatus attribute so to ensure employees are not scheduled when they are off. Employees may also set days on their calendar on which not to be scheduled. This is detailed in the calendar application.

The workStatus attribute in tblSchedule defaults to available but it is updated to offDuty when an employee is scheduled off or their time off request is approved in tbltimeOffRequest for the day under consideration.

Now the application software reads the available employees 2 into memory or data structures ordering them by titles (skills) and categories within the titles for comparison to the pre-established conditions in the database to determine scheduling eligibility. Conditions may include factors such as background check and clearance. A manager title may have project manager as a category and supervisor as another category. The system performs automated scheduling based on, conditions provided on each of the employees, how many hours they have accumulated to date, their skills and job required skills wherein hours to date are accessible via a button link in the mobile app. Workers can respond to the overtime by calling, texting or email.

In another implementation, comparison is done entity (tblSchedule) to entity (tblConditions) without first loading employees into a data structure.

The application then filters for scheduling eligibility by traversing the pre-set conditions in the database 3. The algorithm compares number of hours worked to date (accumulated hours) to the maximum number of hours any employee can work a week to ensure they don't exceed the maximum overtime if any limits are set. The scheduler system of claim 7 provides a means for displaying available overtime to workers on the mobile app as an announcement button link that a user opens to display date of extra time, start time, approximate end time or number of hours, location of extra time and description of the assignment wherein, workers respond to accept the overtime through the mobile app.

If an employee worked a double shift (indicated in workStatus attribute), the algorithm checks the lastWorkEndTime to provide enough rest hours before an employee is schedule again on any of the available projects. For this case, the minimum number of rest hours is preset in the software system.

Each project has different employee needs. The application reads employee titles, skills, categories within the titles, minimum hours the title can work in a week, minimum hours the category can work in a week and restrictions on the employees.

If the employee doesn't pass all those filters 4, they are placed on a waiting list also known as reserve 5 for later consideration. If the employee passes the scheduling filter 4, the application examines employee availability looking at possible start and end times on that day and any restrictions on the employees then schedule them to projects that correlate to the time frames.

The algorithm now reads the available projects 6 and orders them by date and time of execution, project manager or supervisor category requirements and restrictions on employees if any.

Looping through the projects one at a time, the algorithm assigns skills (names) until the total number required is reached 7.

If the number of employees suffices to cover all the projects 8, the application ends the scheduling 9 and updates the workStatus attribute for each employee in tblSchedule to single scheduled. It also indicates in the database the next free times for any other projects starting with the end time of the last project. If there are more projects than available employees 9, the software system reads employees on earliest finishing times 10 that are in vicinity of the projects lacking employees and reschedule them for a double or second continuous shift. Label them as double shift in the individual comment field 11.

If all projects are covered after scheduling employees on two separate jobs 12, the application ends the scheduling 9 and updates the workStatus attribute for employee on two jobs in tblSchedule to double scheduled. It avails the schedule for viewing. If the rescheduling doesn't cover all projects, the application looks on the waiting list were reservists are and select the most eligible employees from the waiting list 13. This feature is changeable from the software system settings. The employer may disable it such that reservists are not selected once rejected.

After adding employees from the waiting list onto the schedule, they are highlighted with a unique color to alert management that reservists were scheduled 14. If some projects still lack employees to execute them, the software system advises management to post announcement for extra time or do whatever they need to do 15. The system is characterized by a method for broadcasting extra time as an announcement button link that a user opens to display date of extra time, start time, approximate end time or number of hours, location of extra time and description of the assignment. The user responds by a single touch on a button link to accept.

After scheduling each employee, the application software updates the workStatus attribute in the entity tblSchedule from available to single scheduled or from single to double scheduled. It then updates the workStatus attributer from double to available after the predetermined rest time has elapsed. The system ends the scheduling and avails the schedule for auto posting 9.

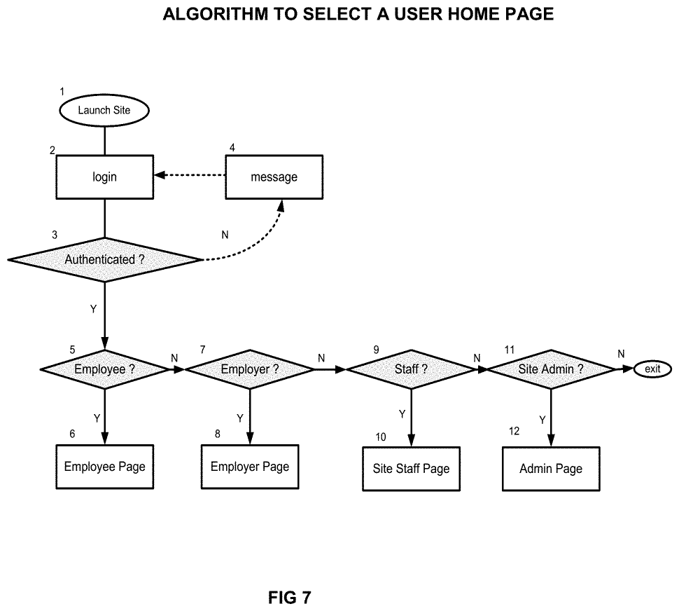

The home selection algorithm of FIG. 7, determines the home page of the person logging onto the application software or website. The launch site button is executed when a user logs in 2 and hit submit. If the user is not authenticated 3, they are provided with a message to either re-logon or contact tech support as seen in the block labeled message 4.

When they are authenticated 3 and found to be of type employee 5, the application reads the user type field from the database and displays the menu specific to that user 6. If it is an employee, the Employee home is shown. If it is an employer 7, the employer home is shown 8, if it is a staff member of the site 9, their home page is shown 10 and if it is a site administrator 11, the site admin home page is shown 12.

This applies to the mobile App that comes with this web application. A remember me check box is provided so that the user can save their password and don't have to login each time. That way, the mobile app defaults to the user's home page.

In addition to reading the user type from the database, the application also reads and returns the company code which is stored in a variable. This company code is utilized in accessing all information from the database including the schedule for a particular company or facility where a company has more than one facility. To display the logged in user schedule, the employee company code is submitted by an algorithm and compared to the multi-company or multi-facility codes for appropriate routing.

The application delivers schedules and relevant information to users based on their companies and specific facilities they work at. It identifies users from different companies by company id or code and directs itself to the appropriate database and or database entities to extract information meant for the logged in user. The user submits a login id or phone number and password. Upon authentication, the application reads user type and loads the user interface meant for that user type. It also returns at least one value from the database, the employee company or facility code and this code is saved in a variable.

When a user hits View Schedule (individual or group), the employee company code or ID identifies the company the user works for and schedule records meant for the code where the user is located and so the employee gets schedule from their facility only. Any other data the employee accesses is identified by the employee ID and company or facility ID.

One or more database entities store the employee schedule for a multi-facility company.

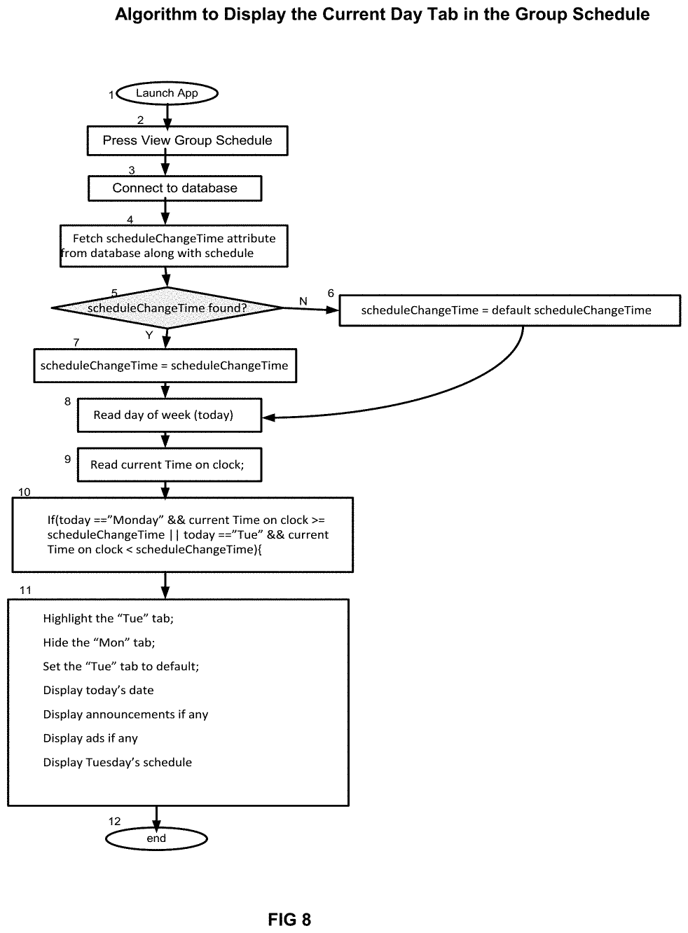

FIG. 8 The tabs of this algorithm are displayed in some of the user interfaces ahead. They are labeled Mon, Tue, Wed, Thu, Fri, Sat and Sun.

In this implementation, the tabs labeled Mon, Tue, Wed, Thu, Fri, Sat, and Sun each break off or hide at the end of each day's schedule. They hide at the time when a new day's shift begins. If a company's daily schedule is displayed at 7:00 PM, the schedule in this application changes at that time (7:00 pm). That time is configured from the settings menu by the employer and the time change attribute is passed on to the mobile app as a tab configuration parameter. The application reads the parameter and periodically compares it to the current time and day of week.

When a user launches the App 1, and presses View Group Schedule 2, the app connects to the database 3, and fetches the schedule along with the Change Time attribute 4. The fetched data also includes formatting data such as highlight color and bold face besides the names and times.

There is always a time such as 7:00 pm when the day's schedule is changed for everybody to see the following day or week. However, the employer can change this time to anything they want from the settings interface and save it to the database. The application therefore reads the database to check for this schedule change attribute or parameter. If it is not found 5, the application utilizes the default one of 7:00 pm 6.

If a new schedule change time parameter is obtained from the database 7, it is assigned to the parameter of schedule time change.

From both steps 6 and 7, the application reads Day of the week 8, and current time on clock 9. If today is Monday and current time on the clock is greater than or equal to the value of the schedule time change parameter (7:00 pm to 12:00 am) or if today is Tuesday and current time on the clock is less than the value of the schedule time change parameter (12:01 am to 7:00 pm) 10, the application executes a series of instructions to display the Tuesday schedule 11 including:
Highlighting the Tuesday tab
Hide the Monday tab
Set the Tuesday tab to the current tab (default)
Display today's date
Display announcements if any
Display ads if any and finally
Display Tuesday's schedule.

The tab for the current schedule is always colored brightly and set to default to show the users that it is the current tab.

The algorithm is also outlined as in the following Pseudo code:

Launch app
Press view group schedule
Connect to database
Fetch scheduleChangeTime attribute from database along with schedule
If scheduleChangeTime not found,
scheduleChangeTime = default scheduleChangeTime say 7:PM // set a
default if not found
showCurrentTab(scheduleChangeTime);
Function ShowCurrentTab(scheduleChangeTime){
Read day of week (today);
Read current Time on clock;
If(today ==″Mon″ && current Time on clock >=
scheduleChangeTime || today ==″Tue″
&& current Time on clock < scheduleChangeTime){
Highlight the ″Tue″ tab;
Hide the ″Mon″ tab;
Set the ″Tue″ tab to default;
Display today's date
Display announcements if any
Display ads if any
Display Tuesday's schedule
End
}

The schedule includes names, start time, end time and any individual comment. The Start Time and Approximate End Times for each shift are displayed at the beginning of every shift schedule.

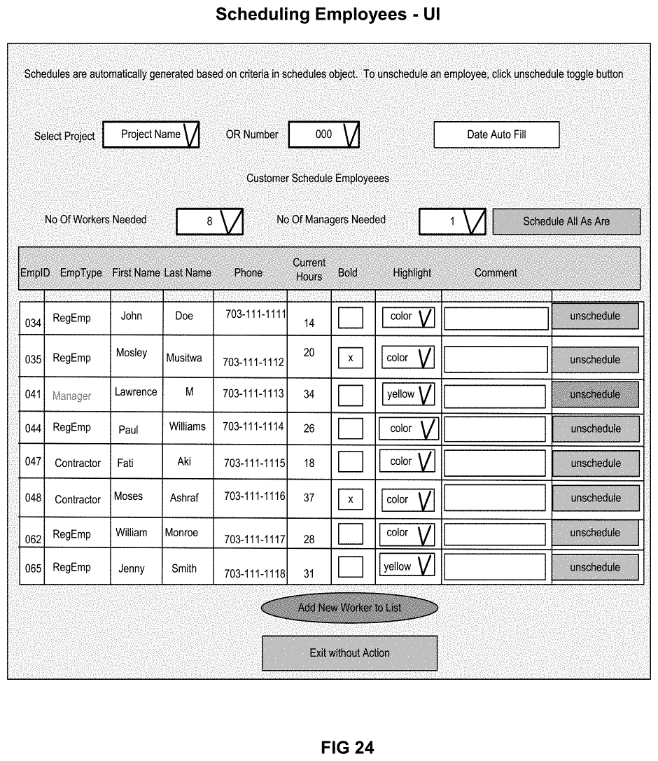

In a second implementation, bar tabs are utilized as seen in the user interface of FIG. 24(b). Here the tab representing the current day schedule is highlighted to distinguish it from the rest. The tab from the previous day schedule is hidden to show only the current day schedule and the reminder of the days or the tabs besides the current day tab may all be left around in the same color.

FIG. 9 The difference between the algorithm of FIG. 57 and that of FIG. 56 is that the later resides on the facility server where data originates from. It has listeners that trigger reading action when a change is detected. The change is replicated to the receiving server in real time without waiting for time intervals to upload data from source to destination (receiving server).

The application software listens to changes in the database 1. When a new patient is added or an existing patient is discontinued, a trigger invokes the application to read the database on the data source server 2. If the change at step 3 is not a new patient addition and it is a discharge of an existing patient 4, the application software loads the data record and flags the patient as discharged 5. It carries with it the discharge date for reference.

If at step 3, the change is a new patient addition, the application checks to see if the patient is assigned medical workers such as a doctor and nurses or drug givers 6. If the patient is not assigned a medical worker, the application software alerts the application users by displaying a visible icon that is brightly colored and in some instances flashing for attention 7, with a record Id informing what record needs attention. Opening the icon gives more details. That record is skipped until it is attended to. That is when the alert is removed.

If the patient at stage 6 is assigned to med workers, they are added to completed cases ready for transmission 8. The application now establishes a connection to the receiving server database to upload the updates 9. If not authenticated at stage 10, the application tries a few preset times and give an error message to alert that data is not being transmitted 11.

If authenticated at 10, the algorithm transmits the completed cases to the receiving server database corresponding to the facility id 12. The database on the receiving server is populated with current patient and med workers 13. The updated data is then replicated to the production server 14. The process repeats 1-14.

If however, one server is utilized as the receiving and production server, replication is not necessary in that case.

This algorithm is used when data originates from the client's machine. Data is always available at the client's machine for the client to print out schedules in case the network is down.

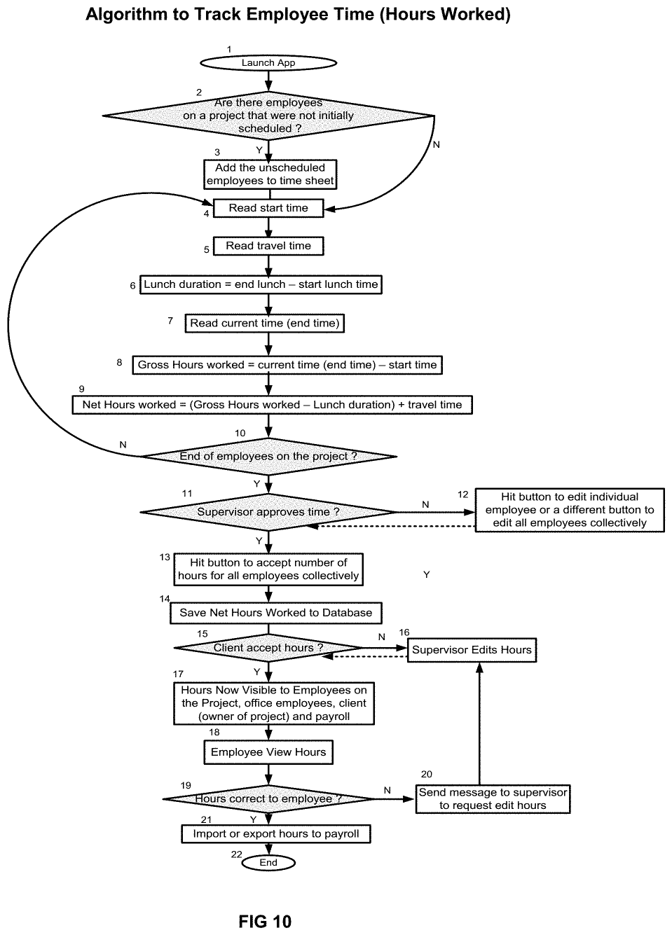

The time tracking algorithm of FIG. 10, executes when the app 1 launches. It starts by providing a manual option for adding employees to the time sheet 2, if there are some that were not initially scheduled but brought onto the project or shift. If there are employees of that kind, they are added to the time sheet 3. If no unscheduled employees are on the project or shift, the application proceeds to read the start time 4. The application continues and reads travel time which could be zero or greater 5. If there is unpaid lunch break 6, the algorithm of the application computes lunch time by subtracting the start of lunch hour from the end of lunch hour.

The algorithm reads the current time which is also referred to as end time 7. The algorithm computes Gross Hours Worked by subtracting start time from end time (time when the job is done)8.

The algorithm further computes Net Hours Worked 9, by subtracting lunch duration from Gross Hours worked and adding travel time to it. The project repeats steps 4 to 9 until all employees on the shift or project are processed 10.

If the calculated time 11, doesn't look good to the supervisor, they can manually edit the time 12 and when they approve it after amendments 13, the supervisor presses a button to accept the hours. The hours are saved to database 14.

At this point, the client or project owner or superior manager can view and approve the hours. If the client finds that the hours are not right 15, they inform the project supervisor who edits the hours after agreeing with the client 16. After approval of both the project supervisor and client or superior manager, the hours are now visible to all the employees that worked on the project, office employees, the client (project owner) and the payroll department 17. At this point, the payroll depart can by means of a button and another confirmation button import the hours into the payroll database. Alternatively, the hours are provided to payroll in form of a file such as excel or .csv which is then inserted into the payroll database. In another implementation, hours are automatically loaded to the payroll database once approved by the employees and client. If after viewing the published hours 18, the employees don't agree 19, employees can send a message to the supervisor to correct the hours 20. If the hours looks good to the employees 21, the system can automatically transfer the hours to payroll or payroll download the hours and end the process 22. The procedure continues for all other shifts or projects the same way.

Time is divided into (1) shift time which is the time employees arrive at the office, (2) start time which is the time a project begins, (3) end time which is the time the project ends, and (4) time off which is the time employees get back to the office where they report initially. In some cases, (3) and (4) may be considered the same time based on company policy. To display a schedule, (1) and (3) are used. To compute hours worked, (2) and (3) are used for some companies and for other companies, (2) and (4) are used.

When employees work on a project, start time and end time are recorded. The project manager or supervisor looks at the project hours and confirm them with a one button click or make minor changes regarding start and end times. The software automatically computes time for each employee assigned to that project.

Utilizing selection menus in a graphical user interface, the software system prevents supervisors from making data entry errors. The selection menus are followed by a software module that analyzes the estimated number of hours to ensure there are no or limited data entry errors. This is for crosschecking the supervisor's time approval.

Once the supervisor or manager approves the time, the external client whose project the employees have worked on have the ability to view the time on their mobile device or computer and approves it too.

Once the supervisor confirms the time on the app, all employees instantly view their time for the day and entire pay period to date. Employees have an option to request for time correction if they feel the supervisor was not right. The button for workers to request for time correction is included.

At this point, the time for the day is visible to the supervisor, the field employees on that project, the external client and the office employees.

Pay role also obtains access to the hours without doing further data entry at the office. This saves time which translates into money.

The time or hours worked can now be automatically uploaded to the payroll department records after the supervisor approves. Alternatively, the time or (hours worked) is provided to the payroll department as a file extracted from the database. This file is then uploaded to the payroll database using a script. There is no need for someone else to do data entry at the office for each employee and for each project. This saves many data entry hours.

### Specialized Skills Special Pay Recordation:

When there is a need for specialized skills such as PC Technicians on a given project, the work done by these technicians is recorded. This information is accessible to the external client that hires the employer's services. The amount of work such as computer connections and disconnections is recorded accordingly. Once the external client approves, the amount of work done becomes visible to the PC Technicians, their field supervisors and employer's authorized workers in the office. If desired, this information may be uploaded to the payroll database automatically for payment to the PC Technicians.

This is more detailed in a separate software system and its database together referred to as the Move Tool.

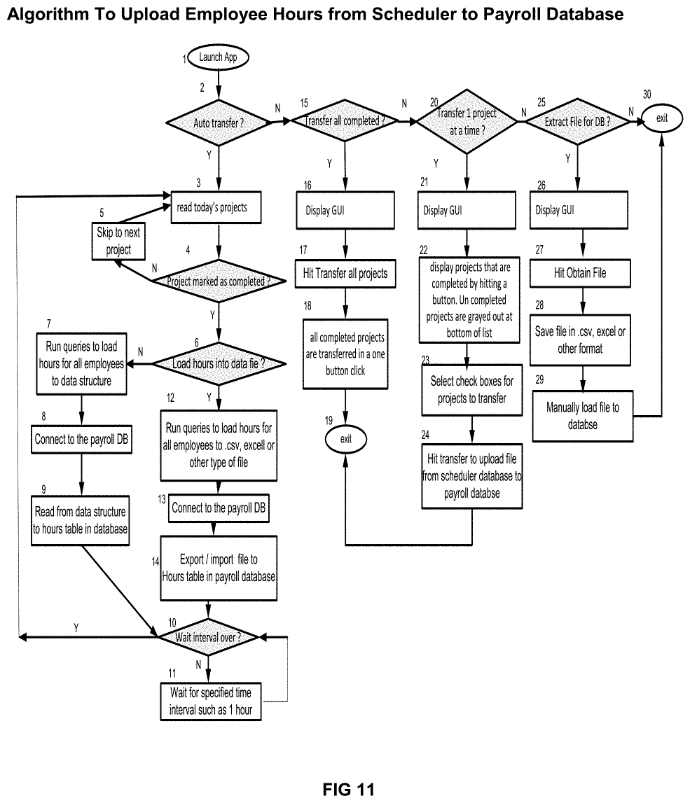

The algorithm of FIG. 11 extracts hours worked from the user accumulated hours in the scheduler database. The hours are extracted from the entity that tracks time which is a result of or mediator between the entity employee and the entity project.

The application provides four options for extracting data from the scheduler database. When the application launches 1, it checks to see if transfer of hours is automatic 2. If it is automatic, hours are read based on the date of interest (eg today) 3. If a project is not marked as completed 4, it is skipped 5 and the next project executes. At the end of the day, all projects are executed and hours are recorded in payroll.

If the project is flagged as completed in the database there are two available methods used to extract the hours. If preference is not to load the hours into a file 6, the application runs queries to load the hours into a data structure such as an array, array list or other 7. It connects to the payroll database 8 and reads from the data structure to the hours table in the payroll database 9.

Reading of the hours from the scheduler database is scheduled at a specific interval. For every interval such as 2 hours referred to as wait interval 10, the application runs queries to fetch the hours. If the wait time interval is not over 11, the application does not read the hours. If the wait interval is over 11, the application loops back to step 3 and starts over.

If on the other hand the method of choice in step 6 was to load the hours into a file, the application runs queries to load the hours into a file such as .csv, excel or other file type 12. The application connects to the payroll database 13 and exports the file to the payroll database 14. The program goes through the wait interval as preset.

The other three options the program provides are all manual and executed via a Graphical User Interface (GUI) on a payroll device.

If at step 2, the configuration is not auto but manual transfer of hours in a onetime fashion 15, a GUI is displayed 16 to provide the option that accomplishes a data transfer with one button touch and a confirmation. The user hits transfer all projects button 17 and all completed projects are transferred in a one button click 18. The application exists 19.

If at step 2, the preferred transfer of hours to the payroll database is that of moving one project at a time or a few projects at a time 20, an option in the GUI 21 provides a button that the user hits to display all projects in process. The completed projects are placed on top in a bright color and the projects that are not completed are grayed out at the bottom in the list 22. The user selects checkboxes for the completed projects to transfer 23 and hits transfer 24 to upload the file from the scheduler database to the payroll database. A confirmation message is provided and an exit option is provided as well 19. A button is provided however for the payroll user to execute all ready projects at once instead of using checkboxes to select.

If at step 2, the preferred method is to obtain a file and use it manually 25, a button in the GUI provides for the extraction of a .csv, excel or other type of file in a one click 26. The user hits the Obtain a File button 27 and the file is saved on the user's machine 28. From this point, the user can manually load the file to a database or use it for any other purpose 29.

The algorithm of FIG. 12 processes medical patients. It launch the application 1 and logon 2. If authenticated 3, the application reads the database and returns user facility code and type of user and store them in variables 4. The application then displays the menu corresponding to the user type 5. That is, if the user is a doctor, a doctor menu is displayed. If the user is a nurse, a nurse menu is displayed. If the user is an administrator, administrator menu is displayed.

If the user is not there to process patients 6 or configure settings 7, they are directed to the settings interface 8 or showed the exit.

If the user selects a choice for Job Detail or process patients 6, the application submits their facility code and user Id to the database for patient data access 9. If the user is not a medical worker 10, and they are an administrator or supervisor 11, they are provided with the medical supervisor menu 12. If they are medical workers 10, the application utilize embedded SQL queries with the facility code to take the user to the right facility 13 and the user id is used to select only patients that are assigned to that user id 14.

If the user chooses to display the case load from the Job Details options 15, the application formats data using CSS and client side script such as JavaScript 16 to display data for the user to view 17. In order to process one case at a time, the user presses individual links within the case load option.

If however the user chose to display Case Details from where they can edit data directly 18, and their device is equipped with a QR or Barcode scanner 19, the worker may scan the patient's wrist band or bed sticker with a code 20 to match the patient code in the application. This code pulls out the corresponding patient record 21 for the worker to edit. It is an added security feature to prevent pressing wrong buttons in case the worker is tired or absent minded.

If however the device does not have a scanner 19, the worker pulls the record manually by touching the buttons corresponding to the patient's ID and service type to confirm they performed the service 22. If data is not saved 23, the process repeats until it gives an error message. If data is saved 23, the application exits that particular activity 24.

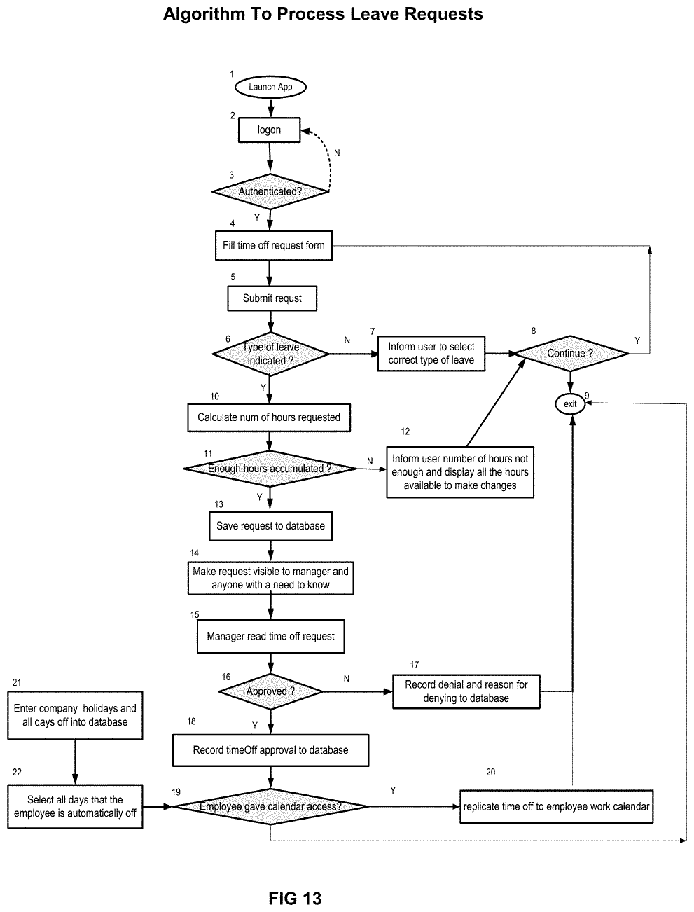

The algorithm of FIG. 13 executes a module that processes employee time off requests also known as leave. When the employee launches the application 1, they logon or if their password is saved, they automatically log onto the application 2. When authenticated 3, they fill the time off request form 4 and submits it 5. If the type of leave to be utilized in the request 6 is not indicated, the user is informed to select the correct type of leave to be used 7. If they decide to continue 8, they are directed back to the leave request form to correct their entries 4 and resubmit or exit 9. However, if the type of leave is indicated and all fields are filled 10, the application software calculates the number of hours requested based on the start date and time then end date and time. If there are not enough hours 11, the user is informed and advised to make adjustments 12 then redirected back to the request form 8, 4.

If the hours accumulated happen to be enough for the time off request, the request is saved to the database 13 and made visible to the supervisor or manager for processing 14. The manager reads time off request 15 and processes it. If the manager denies the request 16, they record the denial and reason for denial in the database 17.

If the manager approves the time off request 16, they record the approval to the database 18. The entity tblEmployee contains an attribute named calendar-Access which indicates to the application whether the employee authorized the application to write to their calendar. The application reads the calendar access attribute in the employee entity and checks to see if the employee authorized her company to write to the employee's calendar 19. If the employee gave the company access to their calendar, the application replicates the time off to the employee's calendar 20. Similarly, all company holidays and days off are entered into the company database 21 and automatically replicated to the employee's calendar 22. Entries into an employee's calendar by the employer application are considered part of a work calendar and displayed in a specific color.

From a separate calendar application, the employee enters their own activities which are displayed in a color of employee's choice. Using that separate calendar application, the employee authorizes friends and relatives to invite her to any function through her calendar. Each person the calendar owner authorizes to edit is provided with an id in addition to their user name which could be email address or phone number. They are authenticated with a password before making any entries to the calendar. Though the calendar executes from an app on the user's mobile device, it is also accessible by logging onto a website for the calendar application. Logging into the calendar website enables authorized editors and readers to have access to the calendar.

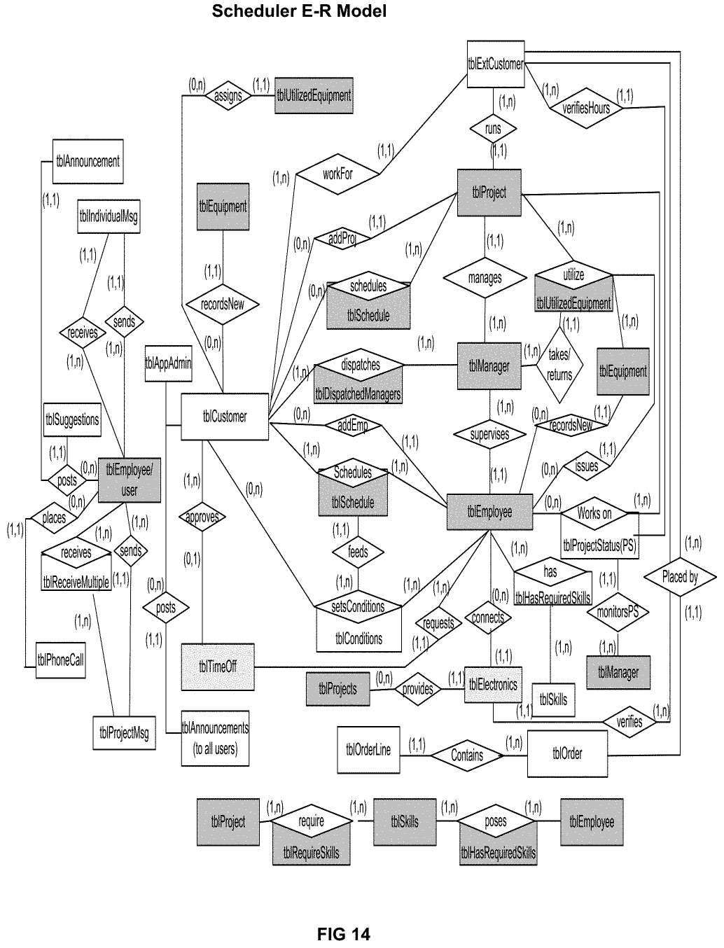

FIG. 14 depicts the Entity Relationship Model (E-R Model) that represents the main database of the application software. Most data pertaining to the scheduler and scheduler activities is stored in the database of this E-R Model. The database authenticates users, allows them to read information including their schedules, enter data of their work related activities and much more.

Based on user type, the database authenticates a user and provides the user type parameter to the application software which in turn displays the corresponding user level home page. A company code or facility Id is utilized to identify the user's company to direct them to the right database and their id to the right data.

The software system enables dispatchers, managers, employees and other employers to enter information that is viewable to people on mobile devices as schedules, announcements, inventory records, extra.

### Equipment Inventory and Assigning Equipment to Projects:

The application provides a feature for entering projects into the system database along with the type of equipment/tools and quantity required to execute the job. It also provides for entering of new equipment or tools.

### Office Managers:

Office managers or inventory manager records all new equipment into the software system. Only these authorized personnel may change that information unless the company wants it otherwise. The changes here include but not limited to adding new inventory and deleting depreciated inventory.

Project Processor (dispatcher manager or whoever does it):

The person that assigns employees to projects may also assign equipment to projects within the system based on the project requirements. After assigning equipment to a project, the warehouse management and field project manager sees this information on their app or computer.

Warehouse Personnel giving out equipment:

Warehouse (or store) personnel does equipment inventory and gives physical equipment to field or project managers (supervisors) per project.

When the warehouse person gives equipment out to a field project manager (supervisor) for a project, the PM verifies quantities received by recounting. The PM then presses a single button on their app to accept the equipment quantities received.

### Project Manager (Supervisor) Returning Equipment

When the project supervisor takes the equipment out for a project, transactions are recorded. Upon return the software automatically reconciles the quantities taken out and returned upon approval of the store personnel with a one button press provided the field PM returns the equipment in the records.

The PM or supervisor in the field may designate any person to inventory equipment at the end of a job. Each person on that project can verify that equipment being returned is the same as equipment taken out. If a company wants only the project manager to do it, then it works that way. Either way, whoever does inventory at the end of a job, their id is automatically inserted into the inventory records to show that they are the ones that counted the equipment so they can be answerable.

The application enables office employees to add projects to the database with necessary stuffing and equipment and also schedules the projects as desired.

The scheduling and dispatch activities are stored for a specific length of time as may be set in the application software. It is purged after that.

The application is interactive in that it allows users to do data entries of different kinds which includes but not limited to interlinked inventory (meaning office, warehouse or storage and field workers read and write inventory data that is visible to all as needed). A warehouse or store user assigns equipment to projects or employees and the activity is recorded in the application database from where it is retrieved for use.

The database also enables any authorized user such as site staff to enter ads that can be viewed the same way as announcements. The ads in form of text, video or audio may be labeled as information or other. Ads are also entered by third parties with authorization. In this system, one App is designated for medical workers, another one for movers and another for restaurant and food workers. However, the scheduler is customizable for other industries. The Secure Scheduling System provides a display for medical workers, movers and food workers to view ads in form of text, audio and video. The said mobile app in the scheduler system also displays ads in form of videos, text or audio in a designated window separate from other content for custom industries. The other industries for which an app is designated includes factory workers and retail workers. The Scheduler App for these uses is built with a window that displays announcements from their jobs as well as ads embedded in by third parties.

The application software has an independent communication module that allows users to communicate one on one or as a group based on a project or job assignment. The communication module is included here but it is claimed as a separate software application that is inserted in multiple applications for the purpose of group or individual communication.

### Internal Communication on a Project:

The application software has a communication module that allows users to communicate one on one or as a group based on a project or job assignment.

If desired, the communication is set to be utilized companywide. The communication module included here is a separate software application that is inserted in multiple applications for the purpose of group or individual communication. It has its own application and database only connected to the scheduler.

When employees are out of site say on different floors or different buildings, a supervisor can easily pass messages through this internal communication module. All employees on that particular project can write to the board to communicate what is going on where they are.

In real life, employees wait for supervisors to tell them the next step after they are done with whatever they were working on. This saves a lot of time which results into money.

Similarly, the calendar application is a separate software application embedded in this application to enhance the scheduling.

The database design also has a part that is dedicated to inventory of equipment, or any other items used on a job. These include prescription drugs, medical equipment, restaurant supplies and so on.

The authentication entity tblUsers, not shown due to space constraints but shown in the schema ahead, contains the AppVersion attribute which is utilized to disable a user's app if needed. When a user requests to authenticate, the application reads AppVersion and if it is not in compliance, the user is advised to update their app. Either a user's email or their phone number attribute is used to authenticate with a password. Whatever the user remembers most.

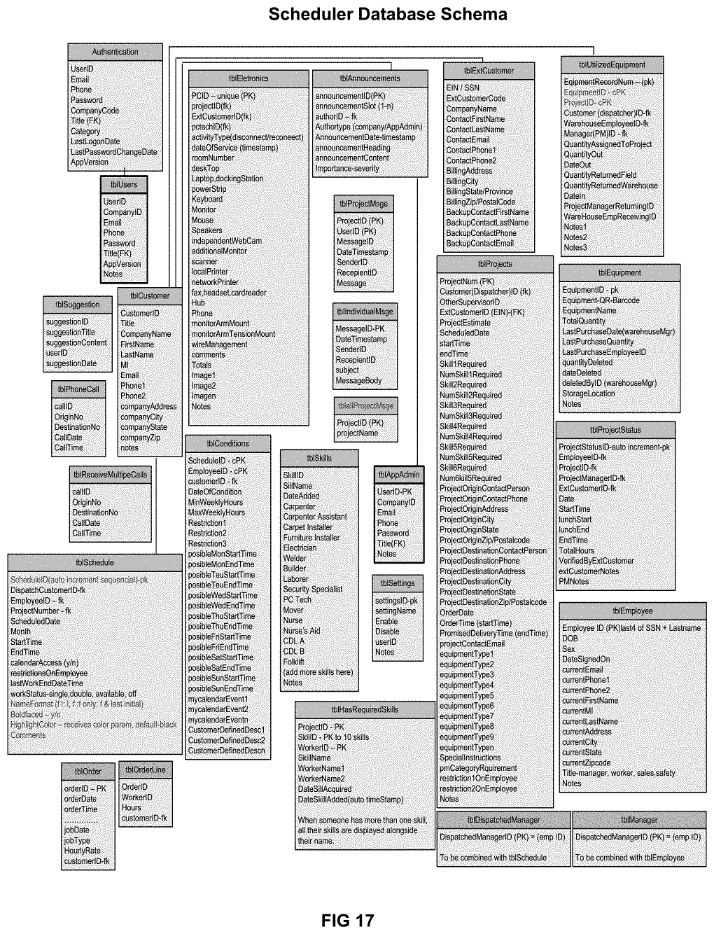

The entity tblCustomer represents an employer or customer of this service. It stores information about them as detailed in the schema of FIG. 17. This entity accomplishes many functions some of which are scheduling of projects, scheduling of employees, setting conditions on employees, dispatching of employees and approving employee time off requests. This entity relates to the tblTimeOff entity that is utilized to store time off requests and related information. When an employee requests for time off, the employer approves or disapproves the time and the information is stored here. The tblTimeOff entity may also be known as tblTimeOffRequest. The entity tblCustomer is also related to the entity tblEquipment in that the customer or employer is enabled to record new equipment of any kind utilized for the job. When the customer assigns equipment to projects or employees, the activity is recorded in the entity tblUtilizedEquipment.

When entering projects into the system, the customer or employer records the type of equipment/tools and quantity. When the project supervisor takes the equipment out for a project, transactions are recorded in the entity tblUtilizedEquipment. Upon returning the equipment, the software automatically reconciles the quantities taken out and returned. The general information about equipment is stored in the entity tbleEquipment. This is further explained at particular user interfaces pertaining to equipment.

The entity tblCustomer is related to the entity tblAnnouncements in that the customer also known as employer, posts announcements to the server into the tblAnnouncements entity and these can be viewed by all users on mobile devices. The announcements expand with quantity of text. When announcement slots are empty, they hide away. Announcements include text, images and videos. Categories of announcements include ads and inclement weather conditions or cancelations of work places. The ads can be inserted into the announcement slots from different sources other than the employer's site or server.

Similarly, the entity tblAppAdmin and tblSiteStaff (not showed), posts announcements and ads that are viewed by all mobile device users. The adds can alternatively be placed in the same entity with the schedule.

The entity tblCustomer adds projects to the database and stores them in the entity tblProject. It schedules the projects, schedules employees, approves or denies employee time off requests, sets conditions on when employees are to be scheduled and sets project executions for external customers also known as clients.

The entity tblCustomer dispatches field managers and supervisors that are stored in the entity tblManager. The dispatch activity is stored in the entity tblDispatchManagers. However, all scheduled employees are stored in the tblSchedule entity for faster processing.

The entity tblCustomer adds new employee to the entity tblEmployee and schedules them to work different times or shifts in the entity named Schedules or tblSchedule. Employee names may alternatively be extracted from human resource records and inserted into the entity tblEmployees. The entity tblSchedule is a product of a many-to-many relationship between scheduling manager or customer entity and the employee entity as well as with the project entity. The primary key for the tblSchedule entity is set to a sequential auto increment number because employees can work double shifts but the software system cannot allow the turple to reoccur in the entity based on this design. Similarly, a project may run for multiple days and scheduled by one or more people. Employee user ID's and project Id's are stored in tblSchedule.

Prior to scheduling, the application reads approved time off request and updates the workStatus field in the entity tblSchedule. If allowed by the user, the application also reads the employee calendar to ensure employees are not scheduled when they are off. After scheduling each employee, the application software updates the workStatus attribute in the entity tblSchedule from available to either single, double scheduled or offDuty.

To speed up processing time, the entities tblDispatchManagers and tblSchedule are combined into one entity that records all employee scheduling activities distinguishing them by titles.

The tbIProjects entity stores all the information about projects including addresses, required number of personnel to execute each, required equipment, required skills on the project and so on. The projects stored in this entity vary with Client Company and their industry. Some companies may have restrictions on employees where employees have to meet certain standards. At least two attributes are provided to store restrictions that may be set by a client of an employee to work on their project. The projects which refers to products could be household goods, office goods, market goods, store goods and restaurant goods. Projects could be human patients in a healthcare setting.

The available addresses include origin and destination. The application software utilizes the available addresses and maps out the delivery routes for a driver to deliver efficiently in the shortest possible time. Convenience buttons are provided. When a project is added to the database, required employee skills and number, and required equipment are entered before the application can auto schedule. The moment a project is added, a trigger is set to alert the dispatch office or responsible office. A color change also shows through the user interface to emphasize the need.

The many-to-many relationship between the Employee entity and Project entity yields another entity tbIProjectStatus.

When employees work on a project, the work activities are recorded in the tblProjectStatus entity. This entity has an auto increment primary key named ProjectStatusID and the two foreign keys project ID and Employee ID. A composite primary key is not used here because employees can be scheduled more than once a day. The tblProjectStatus entity stores the hours worked on each of the projects identified by project ID based on start time and end time of each employee. It stores the project status entity, arrival time and departure time of employees and other attributes. Utilizing the graphical user interfaces provided by the application software, the project manager or supervisor looks into the project hours and confirm them or make minor changes regarding start and end times. Otherwise, start time and end time of a project are pre-entered into the database and are only verified or altered by the field supervisor as shown in the connected entities tblProjectStatus and tblManager. Hours are automactically computed by a touch of a button.

Once the supervisor or manager approves the time, the external client in the entity tblExtCustomer can see the time on their mobile device or computer and approves it too.

At this point, the time for the day is visible to the external client, the supervisor, the office employees and all the field employees on that project.

The time can now be automatically uploaded to the payroll department database if the customer wishes. Alternatively, the time or (hours worked) is provided to the payroll department as a file extracted from the database.

In order to schedule an employee, the customer or employer sets conditions on every employee. These conditions referred to as Customer Defined Conditions are stored in the entity tblConditions. The conditions includes but not limited to times that an employee is not available, and times that they can work. That is, possible start time and possible end times each day. It also includes at least three attributes that hold restrictions on the employee if any but defaults to null for those attributes. Example of a restriction is that of an employee of a certain kind not being permitted to work on a certain job type or for a certain client that processes confidential information. It also stores and provides to the scheduling application minimum and maximum hours an employee can work for a week.

The attribute hoursToDate gives the accumulated employee hours for that week and can be utilized as a cut off point for scheduling or as a consideration to provide more hours to the employee involved. The lastWorkEndTime attribute is placed in the entity to prevent scheduling workers back to back without rest time. A specific number of hours may be set by the customer to rest after an employee works 2 continuous shifts.

All these conditions set the employee's availability each day Monday through Sunday and enable the software to automate the scheduling.

When a project is scheduled, its start times and approximate end times are utilized to look for available employees within those time frames. The queries that search for employees to work on a project utilize project start and end times and employee possible start and end times in addition to the other conditions.

The algorithm also looks in the employee calendar to see when an employee is not available before finishing the scheduling.

In addition, the software application looks into the entity tblSkills when specific skills are required for a project. It extracts people with those skills and provides them for the project. [001] [167] Information about the required skills and employees with those skills is stored in the entity tblHasRequiredSkills.

If an employee is scheduled for a project and they are labeled as double shift employee, the application takes into consideration the end time of the first assignment to ensure the times do not overlap.

The employer or customer only looks through the schedule to make minor changes when necessary.

The entity tblExtCustomer represents external clients of the employer that the employer executes projects for. It stores information about them. The external client places job orders from any device and the orders are stored in the entity tblOrders. The entity tblOrderLine represents individual orders that make up the orders in tblOrders.

When there is a need for specialized skills such as PC Technicians, what these technicians do is recorded in the entity tblElectronics. This information is accessible to the external client that hires the employer's services. The amount of work such as computer connections and disconnections is recorded in this tblElectronics entity. Once the external client approves, the amount of work done becomes visible to the PC Technicians, their field supervisors and employer's authorized workers in the office. If desired, this information may be uploaded to the payroll database automatically for payment to the PC Technicians.

This is more detailed in a separate software application and its database together referred to as the Move Tool.

The communication module attached to this E-R Model is also a separate application/database program that is inserted in multiple applications.

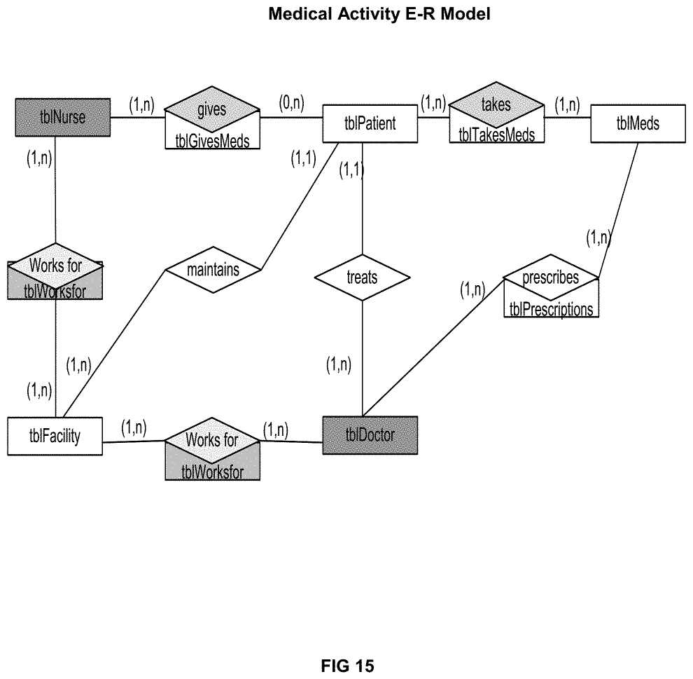

FIG. 15 The Entity Relationship Model (E-R Model) of FIG. 15 pertains specifically to workers in a clinical setting where they deal with medications and other similar items. These includes but not limited to hospitals, nursing homes, prisons, shelters etc.

The entity tblMeds is the record of all medications. The entity tblDoctor represents physicians that diagnose and treat patients. When they do, all patient activity record that includes diagnosis, medications, instructions for taking meds (frequency and dosage) extra are stored in the entity tblTakesMeds.

The entity tblNurse, represents a worker that cares for patients and gives them medications. This worker could be a registered nurse, LPN or any person entrusted to provide medicines to patients.

When developing the database, the entities tblDocter and tblNurse are combined into one entity tblMedWorkers for faster processing. The medical workers are distinguished by their titles in this entity.

The entity tblGivesMeds from the many-to-many relationship is the one that stores information regarding activity of the drugs. That is, each time a patient takes prescriptions or anything of the kind, it is recorded in that entity for tracking.

Similar to tblMedWorkers, the entities tblTakesMeds and tblGivesMeds are combined for faster processing.

The entity tblPresciptions keeps records of medicines that are not related to any particular patient.

The entity tblPatient, represents a sick person that is given medications. It contains an attribute named status or patientStatus which is either active or discharged. It helps to maintain the number of cases assigned to each health care worker. It is updated when a patient is discharged so that the discharged patient doesn't show up under anyone's cases. Triggers are set on this entity so that each time a new patient is added or an existing patient is discharged, the trigger activates the application to read the database and send updates to the receiving server that feeds the production server from which mobile applications draw data.

The application software authenticates users to enter and retrieve data in the database that is generated from these entities.

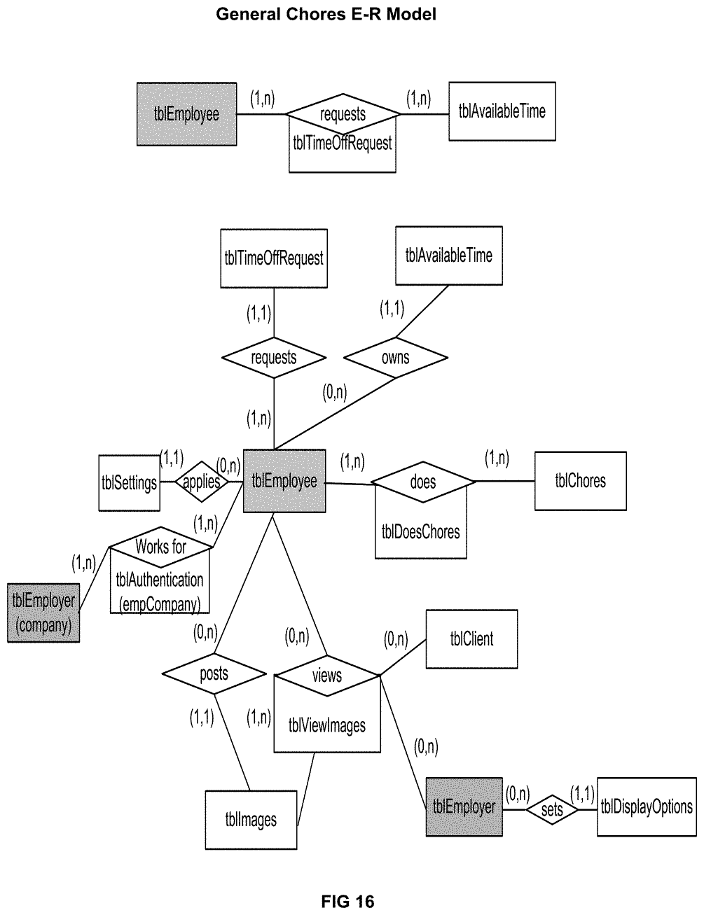

FIG. 16: The entity relationship model of FIG. 16, represents data storage and retrieval of employees in any labor category. It also represents user interface display options. This is used to customize applications based on a company's needs. The entity tblChores represents storage of data on any chores or items that an employee works on. The entity tblDoesChores from the many-to-many relationship is the one that records chore activities and it is queried for information pertaining to the job involved.

The entity tblEmployees stores information about workers. It is detailed in the main E-R Model. Workers can record what they do including posting files, text and images. The workers or employees, their supervisors and clients are authenticated to view any of the postings. One example, a client may want someone to take pictures of something such as a building very far way. That customer gets a temp worker who takes the pictures and uploads them to the application's database for the customer retrieval. Any pictures taken and uploaded by employees are visible to their employers or clients whose information is saved in the entity tblClients. The client is also referred to as external customer. The Employer entity represented here by tblEmployer is detailed in the main ER-Model.

The entities tblEmployee and tblEmployer generates a third entity known as tblEmpCompany which stores a foreign key attribute from each of the parent entities. It is used as an authentication entity. It stores attributes that include the employer or company id (company code), facility code and employee id. The company id directs the application to the company database and the facility code specifies which entities the particular user id can access.

The employer sets options on how the application is displayed and the options are stored in the entity tblDisplayOptions which is read by the application to display things such as tabs, name format, shift display style, time display style and schedule length. The Secure Scheduling System provides dispatchers with touch or click options to display employee schedules for single employee, by project, by supervisor, by department or all employees at once.

The entity tblTimeOffRequest is utilized to process employee time off also known as leave. The employee ID is placed in this entity to identify the employee being processed. The supervisor or manager and many other attributes are included in this entity to enable the process of request and approval. The entity is also showed in detail in one of the schemas. When time off request is approved, it is flagged as approved. The application reads this approved time off request and updates the workStatus field in the entity tblSchedule to indicate the person is off before the scheduling takes place. In addition, the application reads the entity tblHasRequiredSkills and tblConditions in main ER-Model plus the employee calendar to ensure employees are not scheduled when they are off.

The entity tblAvailableTime stores accumulated employee time. It is this entity that the application reads from to see if the employee has enough time to cover the leave request. The employee also gets amount of time available from this entity displayed in their app when they query the database using a button named Available or accumulated time. The query displays to the employee all the time they have so that they can choose what to utilize when requesting time off.

The entities are represented in two different ways as showed in the ER-Model of FIG. 16. In one design showed on top of the ER-Model, the tblTimeOffRequest is a result of a many-to-many relationship between the other two entities tblEmployee and tblAvailableTime. It stores time off activities each time an employee requests for time off. It records accumulated time reductions and dates when time is used.

The tblAvailableTime stores the time that accumulates and tblTimeOffRequest stores the time activities that change at each time off request. Some of the attributes in the tblTimeOffRequest entity are time type ID, user id, number of hours requested, last date used, last no. of hours used and comments. The employee ID is placed in each of the time type in order to link the employee to the time available as showed in the ER-Model. Each time an employee takes time off, it is reduced in the tblAvailableTime entity.

The tblSettings entity is utilized to store display configurations set by the scheduling person. Output formatting parameters such as highlighting names or bold facing are included in the database so that the scheduling person does not have to deal with html code. All they do is place checkmarks to radio buttons or checkboxes and the commands are stored in the database table for the application. The application retrieves the commands as attribute and passes them to the client side script with embedded cascade style sheet code or bootstrap to apply the styles. Alternatively, settings for formatting schedule output are placed within the schedule entity to speed up query time.

Similarly, all user settings are stored in a similar entity. The user settings button links to the user id in another settings entity or object. All the selections they make are retrieved by the application and applied to their interface to change appearance.

FIG. 17: The schema of FIG. 17 represents most of the E-R Model of FIG. 14 in a detailed fashion that shows attributes. The entities are not normalized at this point.

The restrictions attributes in the conditions entity are utilized to filter employees with limitations from working on certain projects. A separate entity not shown is written to by clients from the Move Tool. The client shows what kind of employees shouldn't work on that particular project. Data is read from that entity during scheduling to filter out those types of employees from the particular project.
The attributes in each of the entities show what the entities stores. The foreign keys show how the entities relate to each other and how they are utilized.

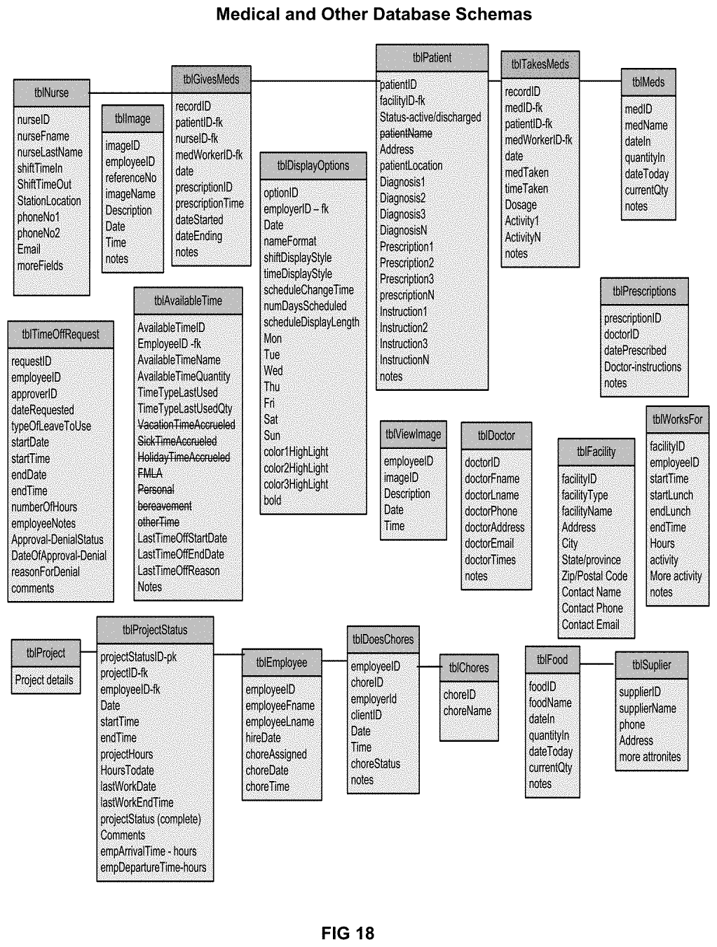

FIG. 18: The schema of FIG. 18 represents the medical E-R Model of FIG. 15 and the Chores E-R Model of FIG. 16. The entities and their attributes as shown, enable data storage and retrieval.

The entity tblDisplayOptions stores application display options set by the employer. These includes but not limited to:

The name format where names can be displayed as first name only, first name last name, last name first name, last name only, first name middle initial etc.
The shift display style attribute refers to displaying of a schedule by project, by supervisor, individual schedule, group schedule etc.
The time display attribute is used to display only start time, start and approximate end time or otherwise.
Schedule change time is the attribute that provides the time at which a daily schedule is posted. It allows the application to automatically replace the previous schedule with a new one.
The number of days scheduled attribute ranges from zero to three hundred sixty five. The tabbed interface with seven tabs uses only eight days which are 0-7.
The schedule display length tells the application whether to display the schedule day by day, that is, next day or week schedule or months schedule or date range schedule where a user selects a start date and end date to get a schedule.

However, if a schedule is set for multiple months, there are user interfaces utilized for displaying entire year schedule one month at a time as the user opens a tab.

The days labeled Mon, Tue, Wed, Thu, Fri, Sat and Sun are utilized by the application in conjunction with the number of days scheduled when formatting the seven day tabs.

When an employer schedules a date, a corresponding day of week is obtained and status is saved in the variables Mon-Sun. To view a seven day schedule, the seven day tabs are used by default. However, current day of the week may be Thursday when an employee is viewing the schedule. This leaves the employee with choices of Thu, Fri, Sat and Sun only. In this case, if they want to view seven days and not only the days that are left off in the current week, the employer configures the software system to work that way and a different interface is utilized to show seven or more days of the schedule.

The color N high light attribute where N represents a number 1, 2, 3, . . . N are different colors that an employer can pass to the application as parameters to highlight name(s) or do any other formatting at the user interface level. Similarly, when the bold attribute is passed on as a parameter, it enables the application to format the corresponding text such as names to bold face. These parameters are retrieved from the database after employer configurations. The parameters are passed on to the client side script that invokes corresponding functions with embedded styling corresponding to the passed parameters.

In the entity tblWorksFor (tblEmpCompany), the company id, the facilityID or code allows a user to access data from that facility only. The user type code allows a user to access data pertaining to their patients only or their work section only.

The facility attribute in the patient entity identifies the facility such as hospital or nursing home where a patient comes from and the particular branch. The facility attribute used together with the employee ID in relation to the tblFacility entity enables the employees such as doctors and nurses to access records of their patients from the tblPatient entity.

That way, employees only access patients they are assigned to. During the implementation phase, all medical workers may be placed in one entity named tblWorkers or tblEmployees and identified by job title.

The entity tblTimeOffRequest is utilized to process and truck employee time off. It contains the attributes including request ID, employee ID, date of request, type of leave request, start date of leave, start time, end date, end time and number of hours calculated by the application system. When an employee submits a time off request, it is saved in this entity. It becomes visible to the manager who then approves or denies. The manager has a space for writing a reason for denying the request and this space is represented by the attribute reason for denial.

The rest of the entities store data as showed by the attributes and are utilized based on the relationships as shown by foreign keys after normalization. The database schema is customization to fit licensee needs.

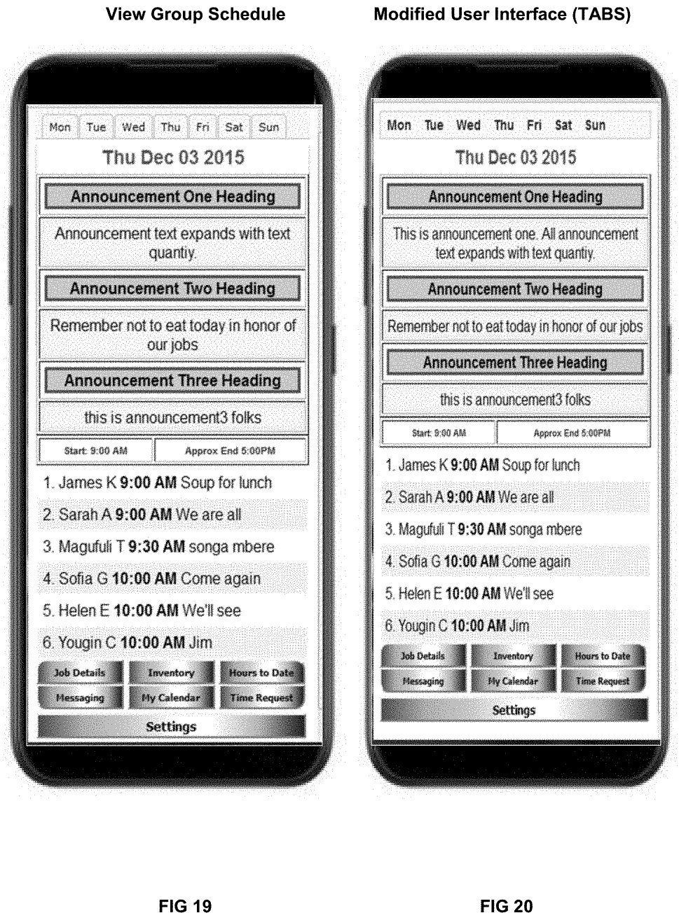

FIGS. 19 and 20 The user interface of FIG. 24 is displayed when a user presses the View Group Schedule button on the seven day schedule. The difference between FIG. 19 and FIG. 20 is that FIG. 19 has individual tabs on top and FIG. 20 has bar tabs. Both UI's display the date followed by any announcements that come with specific title displays. The announcements include text, images and videos. Announcements display as ads.

If necessary, start time and approximate end times are displayed at the end of each group schedule. The displayed schedule shows a number, a name start time and comments if any. The schedule is then followed by button links that perform various functions some of which are applications on their own.

Under this implementation, the tab that reflects the current day is highlighted to emphasize that day. If a user happens to open another tab, that outer tab is highlighted with a different color such as grey to show that it is not the current day. Under both UI's, the tabs that represent the past day schedule are made to disappear.

The job details button link is provided to give each employee all the necessary information including but not limited to Job number, Client company, job site addresses etc. If the employee is a supervisor, they get contact information of the customer. All employees on a particular project may have customer contact in the app during the project if the company wants it that way.

If desired, contact number for each employee is availed in the app only for the people on that particular project. That helps any employee to look for another employee that is out of site when a job is ongoing. The mobile app displays worker names and times they are scheduled to start work. It also provides a button for inventory, a button for checking hours to date, a button for messaging, a button for accessing the users calendar and a button for requesting for time off.

The installable mobile app in this system displays a listing of workers with their names, current hours to date, name formatting options including a highlighter, bold and italicize for emphasis wherein a schedule button, checkbox or radio button is utilized to schedule an individual or group.

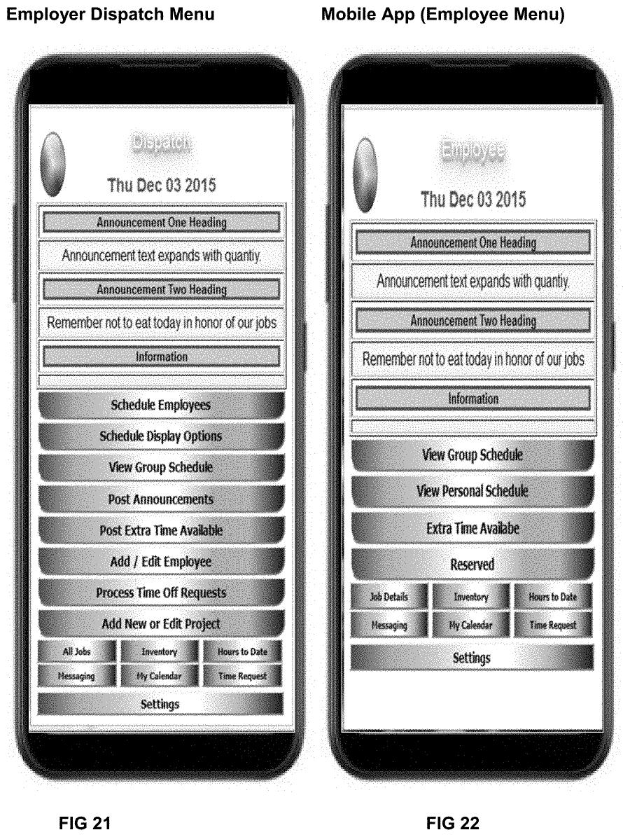

FIG. 21: After adding a project to the application database, the office employee uses a button that is not showed here to assign required number of employees and their skills to the project. This button is labeled “Assign Employees & Equipment”. The user interface displayed by this button, also allows the user to add quantity of equipment needed for the project. The User Interfaces (UI's) showed here area also available on large screens.

The Schedule Employee button link in the UI displays the schedule that is generated automatically. If desired, the office employee can edit that schedule as desired. The Schedule Display Options button link provides a UI that enables the employer to choose how the schedule displays by selecting radio buttons or check boxes or drop down menus.

The View Group Schedule button link displays the schedule to the employer the way employees view it so that they know how it is showing. Post Announcements opens a UI that allows the employer to post announcements into text areas or text fields. The announcements are then saved into the database from where the application reads and displays them. Post Extra Time Available opens a user interface from where the user posts the extra time available or over time for workers that may be interested. The workers view this from their device using the Extra Time Available button link which is lit when active. The Add/Edit Employee button link provides a UI that enables a user to add a new employee from anywhere or edit an existing employee.

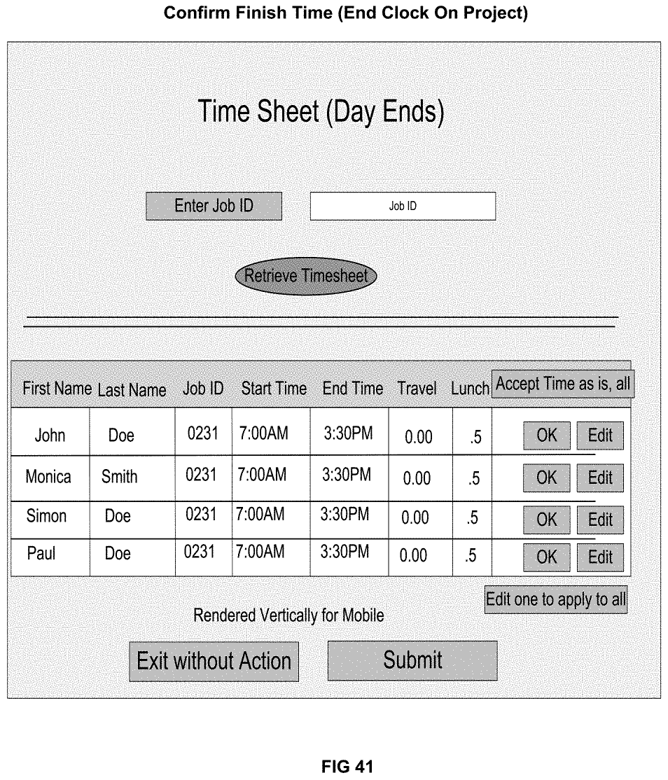

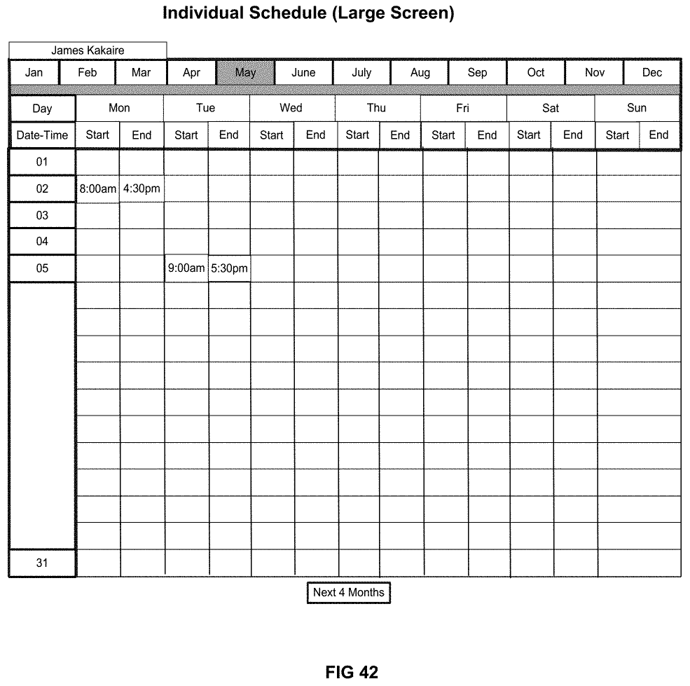

FIG. 22: When a user of type worker logs onto the mobile app, they get a user interface similar to that of FIG. 42. If they place a checkmark in the remember-me check box or radio button in the initial screen, their password is saved and they are not required to login again unless when they un-save their password from the settings menu which also provides password reset.

The user interface of FIG. 42 is the general UI utilized by most employees regardless of industry. It is edited slightly for every industry to reflect what they do. The selection choices incorporated therein namely View Group Schedule, View Individual Schedule, Extra Time Available and Reserved are already described under the supervisor menu. The choices at the bottom of the screen which are on every user interface are described ahead.

The UI in part (a) has a logo image placed on the left part of the app and a three dimensional transparent text is used to describe department or company name. That is followed by the date display which shows current day of the week and today's date. If a client desires, current time is displayed as well.

The date is followed by one or more announcements that automatically fill in from the server based database and go out to all users of the application. Each announcement has a title and content which are entered separately. They can be configured to display the most important announcement in a different way based on priority selected by the announcer.

The announcement slots display different items including text, images and videos. One slot can also have more than one announcements manually separated by the user that posts the announcements. Otherwise all announcements are entered in a text field or text area from a computer or mobile device and they are saved to the server from where the mobile app retrieves them.

When announcement slots are empty, they collapse providing more space for other items to display in their space. The size of announcement display window depends on text quantity but there is a maximum size that can be set to limit the number of characters that can be displayed at once.

One or more of the announcement slots is used to display ads that may be from different sources.

The UI of part 42 (b) differs from that of part (a) in that the heading text that describes a company name or department is placed on the image and centered. It is used as a logo in that manner. On the logo, the company name is shown in a transparent manner that allows both to display.

The View Group Schedule button launches a schedule that shows all scheduled employees.

The View Individual Schedule button displays only the user's schedule for a specified time period. It could be a week or monthly schedule depending on what the employer want them to see.

Not shown below this button is the Range Schedule button and corresponding selectors that selects time intervals. A user selects starting date and end date and they view their schedule between those dates.

The Extra Time Available button displays announcement specific to impromptu available time. That is, when one calls in and the employer needs a replacement or there is a need for filling in on an impromptu project. The button changes color when there is information. Additionally, an alarm can sound or the device may just vibrate or a combination of that.

Another button View Employees On Project, not showed display only employees on a specific project that the app user is part of. This feature is also included in the job detail button. When a user is not scheduled for any project, they see an empty page message.

The group of buttons in the footer area of the application has specific functions and some of them are interactive. Each of the buttons is further illustrated with a user interface ahead but a brief overview is provided here.

Also not shown on the main menu of the first user interface after logon, is the Update Personal Info button. This button takes the user to another UI where they can edit their personal information such as address, email, phone number etc. Alternatively, updating personal info is done from the settings button.

The button labeled as Reserved, is reserved for a separate application relevant to the users of a particular company such as the Move Tool used in the moving industry.

The Job Details button provides details of a job that includes project number, project name, location, times involved, contact people in case of need and so on etc.

The Inventory button displays a menu based on duties of the user. If the user is say an office personnel, the menu they get allows them to add new inventory, view reports etc. If the user is a warehouse or storage user, their menu allows them to give out whatever is inventoried and receive them back if necessary. They maintain the inventory in storage. That inventory is compared to the new inventory entered by the office manager and discontinued items for accuracy. If the user is a field employee that takes out items, they get a menu that corresponds to what they do. The bottom line is to maintain checks and balances in regards to the items used.

Next is the Hours to Date button. This button displays hours of an employee for a day and any specified period of time such as a week or pay period. Hours are maintained in the system for reference until not desired. At the end of each day or pay period, hours are exported to the payroll department for payments to be made. If an employee notices discrepancy in the hours, this feature includes a form they fill to rectify the problem. Changes can be made visible to the employer and external customer.

The next button is the Messaging button. It represents a separate application that is just embedded in this application. This button allows the application users to communicate on a one on one basis and on a project by project basis. They can also communicate on a company wide basis if the employer allows that. The employer controls this application from the settings of their user interface.

Next is the My Calendar button. This button also represents a separate application that is embedded into the scheduler for efficiency. It is a user calendar that resides somewhere else. It shows dates when the employee is available. This calendar is accessible to the employer and the scheduler application. The scheduler application directly reads availability information from the user's calendar and schedule accordingly. However, the calendar owner authorizes whoever accesses it.

The Time Request button is used by employees to request time off from work. This includes vacation time, sick time and all kinds of time that the company offers. When the time off is approved, the application writes it to the user's calendar.

The Settings button allows the user to customize the application. Multiple configurations take place from the settings menu. A user can also update their personal information and change password from the settings menu. At development, the Settings button link may read (Settings and Suggestions) to include a text area and submit button where a user can type a suggestion and send it to management. The suggestion is saved in a database from where management can read it. The suggestion is utilized by management to improve on how the company is operated. Alternatively, the suggestion text area and submit button are placed in either the emergency contacts or a link is placed on the main menu.

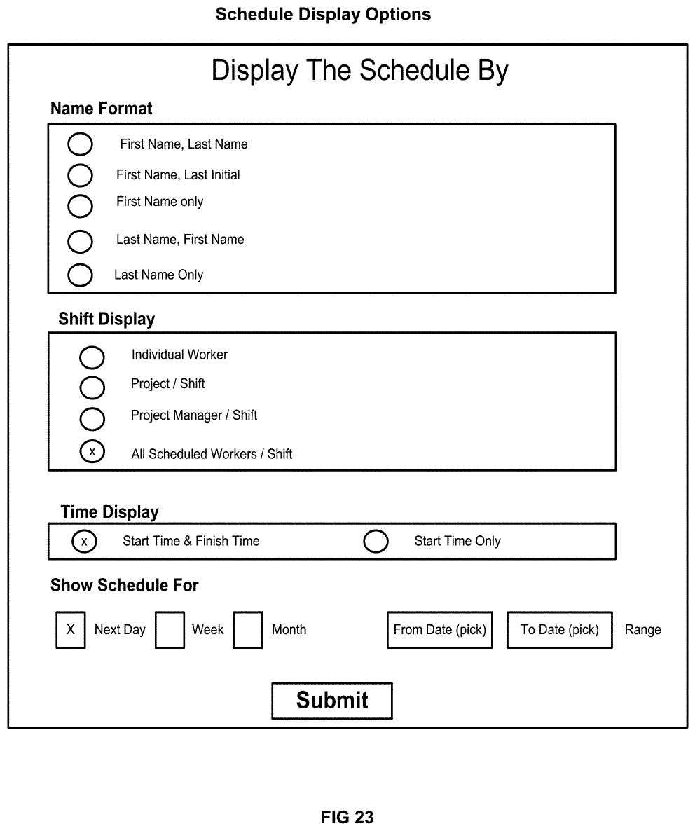

FIG. 23: The system provides the user interface of FIG. 23 from which the schedule is styled and displayed based on name format, shift display, time display or length of schedule. Checkboxes, radio buttons and dropdown menus are utilized to accomplish the tasks.

The user interface provides selection options for a user to style a schedule and to tell the application what kind of schedule to display and how to display it. Users choose to display the schedule by first name then last name, last name then first name or first name only or last name only.

The system provides employers with settings options (not shown) to restrict workers from viewing any other person's schedule besides their own. The settings also provide an option for showing or not showing the job end time.

The Secure Scheduling System provides dispatchers with shift displays that have touch or click options to display employees individually, by project, by supervisor or all employees at once.

FIG. 24: The user interface (UI) of FIG. 24 is the one that displays when a user selects Schedule Employee from the main menu of the employer. It provides a list of all projects under drop down menu. The user selects a project and sees the corresponding schedule. Alternatively, they enter the project number the project schedule displays. They can edit the schedule by highlighting employees, bold facing names, un-scheduling them or adding new employees manually to the schedule.

The system displays a listing of works with their names, current hours to date, name formatting options including a color highlighter, bold and italicize. A schedule button or checkbox is utilized to schedule an individual or group.

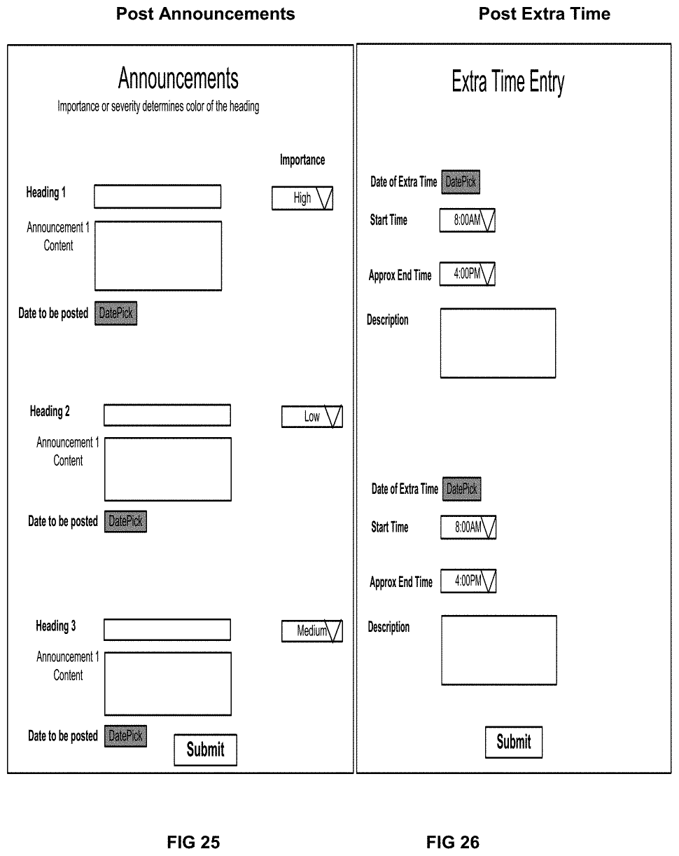

The UI of FIG. 25 is what an office user gets when they select post announcements. It has a heading section for posting the title, a text area for textual, image or video content and a date picker that tells the application when to display the announcement. The importance drop down menu changes color of the heading to emphasize its importance. Announcements may be advertisements or information. Not shown are the buttons for uploading videos and setting the exact time to display.

The user interface (UI) of FIG. 26 is utilized to post extra time or over time available. It provides a date of extra time to choose, start time and end time and a description of the work to be done. Multiple Extra times can be entered. Multiple extra times displays to the reader as a list of extra times and they have to open each individually for details.

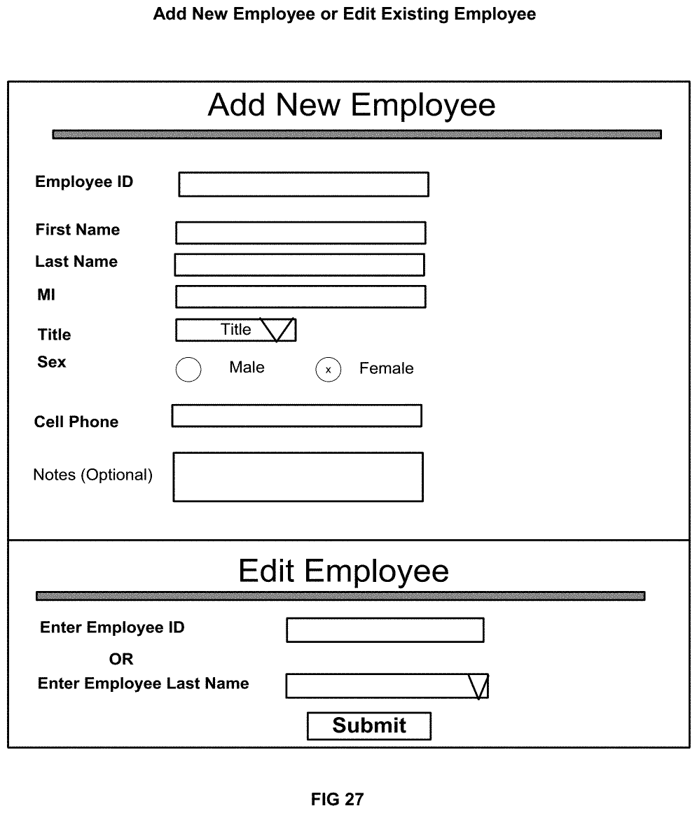

The user interface of FIG. 27 is utilized to add new users to the scheduler and edit existing users. Prior to scheduling, the application allows the authorized office users to add new employees, their skills and availability records or conditions as necessary. The system reads the employee records and automate the scheduling without human intervention. Alternatively, employee names are extracted from human resource records and inserted into the application's database. In this case, records are only edited by adding availability and other conditions.

The conditions include times that an employee is not available, and times that they can work. They also include hours to date, minimum and maximum hours an employee can work. These conditions enable the software to automate the scheduling.

While scheduling, the software application looks into the skills possessed by workers when specific skills are required for a project. It extracts people with those skills and provides them for the project. The employer or customer only looks through the schedule to make minor changes when necessary.

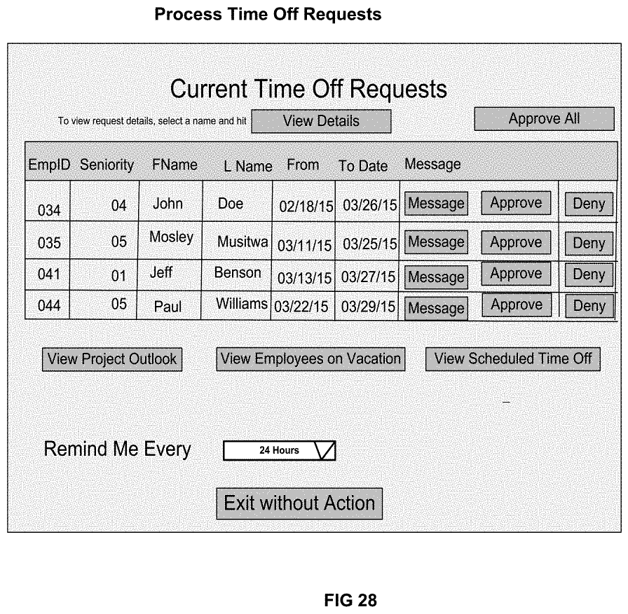

FIG. 28: To view details of the time off request, the manager selects a name and hit view details. The Approve All button executes a command that approves all applicants. The Approve button approves individual names and the Deny button denies individual names. The message button displays details of the request including type of time to be used. When the Deny button is selected, it provides a text area to enter a reason for denial. The View Project Outlook provides status of projects being executed. The View Employees on Vacation button displays all people on vacation during that time and when their vacations are ending. View Scheduled Time Off displays those that are scheduled to be off.

The user interface displays vertically on a mobile device such as a mobile phone.

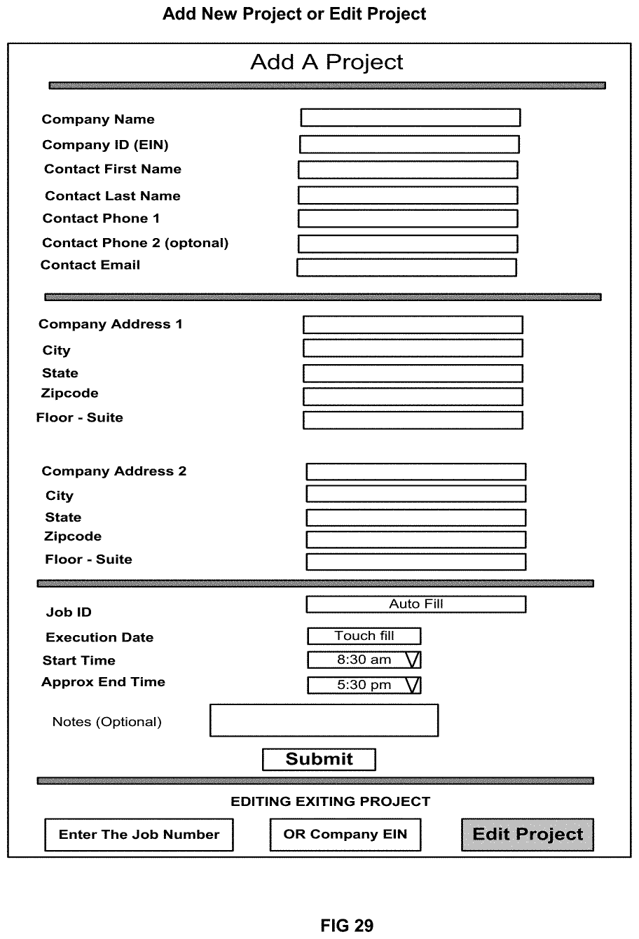

interface of FIG. 29 is utilized to add new projects or edit existing ones.

A project may refer to a moving job for moving companies, a patient for medical personnel, a wait job for a restaurant or any other job performed by one or more employees in a specified period of time.

Upon adding a project, the user is prompted to add number of employees to work on the project and necessary equipment if any. It provides another interface for adding numbers of employees needed and equipment.

When a user goes to view a list of projects ready for execution, the one's with numbers of employees and necessary equipment assigned shows up on top in a bright color such as green. The one's that needs adding numbers of employees and equipment are grayed out and a button is provided to click and get an interface for entering no. of workers and necessary equipment.

To edit an existing project, the user selects a project from a dropdown menu or enters a job number or company employer identification number (EIN) and hits Edit Project. This pulls up the project with that job number from the database and places it in the user interface for editing.

Users comment on time or hours worked, requests time off and perform messaging communication within the application. From the main menu, they also update their personal information such as address, email or other.

FIG. 29 adds projects to the software system for auto scheduling. The system provides access to second and third party clients to enter work projects providing parameters that include number of employees required for a job, required skills, start date, start time, end time, job duration and ads in form of text, audio or video wherein the parameters are utilized during auto worker scheduling to display the contents in the mobile app. The employer and their clients both enter new projects. Each project saved is saved along with the identification of the user. For projects entered by clients, minor edits are made to make them ready. These edits are in form of assigning number of employees and necessary equipment to work on the job as well as estimated duration of the job. The parameters which include number of employees required for a project or job, start date, start time, end time and job duration are utilized by the application software in auto scheduling.

The system provides second and third party clients access to enter work projects providing parameters that include number of employees required for a job, required skills, start date, start time, end time and job duration wherein the job parameters are utilized for auto scheduling.

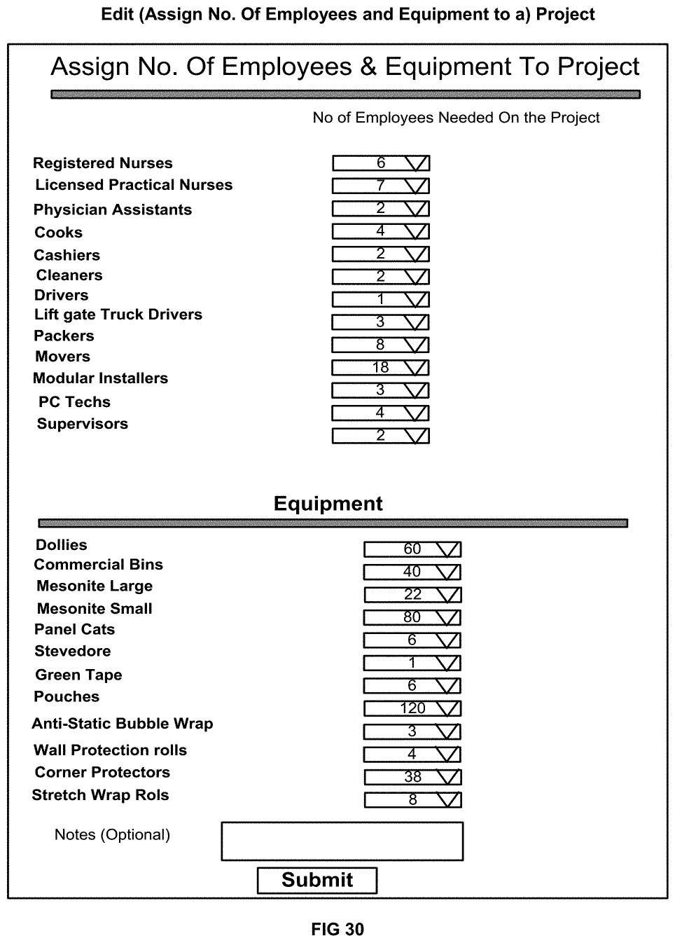

FIG. 30: The user interface of FIG. 30 pops up when an employer submits a new project. If they don't continue and work on it later or if the project was entered by a customer, the employer clicks edit project and they get the above interface. Alternatively, when they press open the All Jobs tab, they get the option to add number of employees and equipment.

The number of employees assigned to a project in the above user interface (UI) is used by the auto scheduling algorithm to select number of employees for a project as indicated. The algorithm considers not only numbers but the skills indicated in the UI. These skills are sample representatives but more skills are included in a production program depending on industry and company utilizing the application.

The equipment on the other hand gets visible as scheduled to the warehouse inventory personnel and moving supervisors. The moving supervisor or truck driver takes the equipment and reconciles with the warehouse upon return.

Once number of employees needed to execute a project is entered along with any required equipment, the scheduler utilizes that data to auto schedule employees.

### Assigning Employees and Equipment to Projects for Field Access:

When an office employee enters projects into the system and assigns employees to specific projects, the employees get to see the projects they are assigned to, the vehicle they are assigned to and all job requirements of that particular project. Only people whose names are on the list for that project can view information about the project. Any name can be added to the project as needed and once added, the individual instantly gets access to the project information. This saves individuals and the group on the project lots of time.

Vehicles and equipment are availed to the scheduling system with their capabilities. The system takes job requirements and match a vehicle from among the functioning and available vehicles. The scheduling system assigns a vehicle and equipment to a job to which workers are assigned. The equipment and vehicle assigned to the job becomes visible to the workers from the mobile app.

### Assigning Equipment to Projects for Field Access:

When assigning employees to projects, the office personnel can assign equipment as well. The equipment assigned to projects is visible to all employees that work on that project and warehouse employees as well. It becomes easy to take out and record equipment inventory as well as returning it and balancing the equipment records.

FIG. 31: The supervisor menu of FIG. 31 represents what a supervisor views on mobile device. View group schedule displays a seven day group schedule which provides a button for viewing an extended schedule. View Individual Schedule displays a one person schedule as seen in one or more user interfaces ahead. Get Equipment button link is utilized for acquiring equipment and maintaining equipment inventory. The Confirm Start Time button link displays employees on a specific job with all their times. Pressing this button and confirming it registers the start time on a job. The supervisor can manually edit the start time. Extra Time Available displays extra time or over time the employer want to communicate to the employees. This button link changes color when there is extra time. The Update Equipment Inventory button link provides an interface for the supervisor or anyone else to update inventory records when they return the equipment taken out. Edit Time Sheet allows the supervisor to edit the time sheet if they find something to be incorrect. Finally, the Confirm Finish Time button link displays scheduled employees on a project or job at the end of the day to complete the time sheet and record the hours worked in a database.

The Job Details button link, Inventory, Hours to Date and Time Request button links provides corresponding user interfaces to execute those functions. The Job Details on the employer menu changes to All Jobs which provides a listing of all jobs being worked on. The calendar and messaging are separate applications inserted in this scheduler.

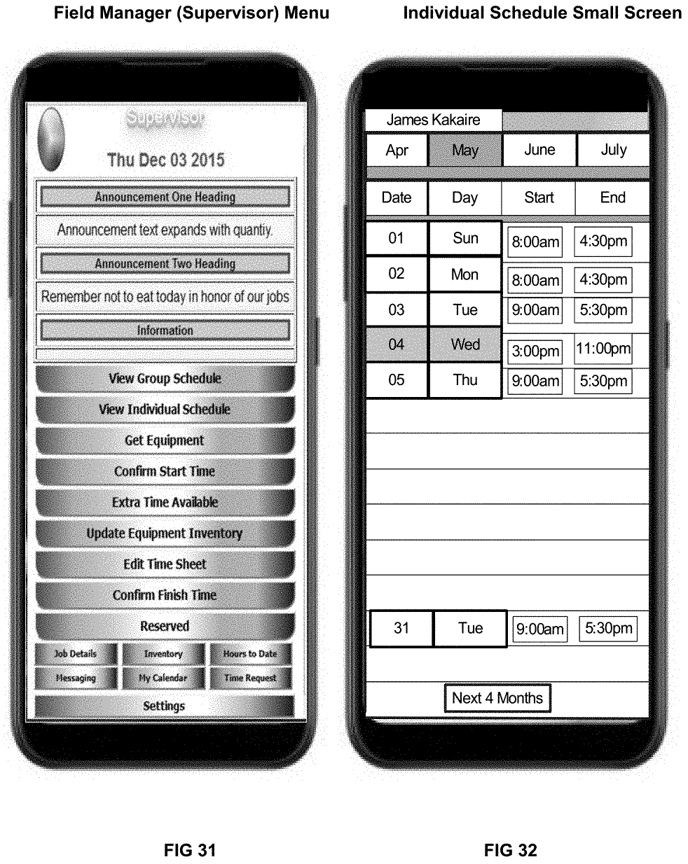

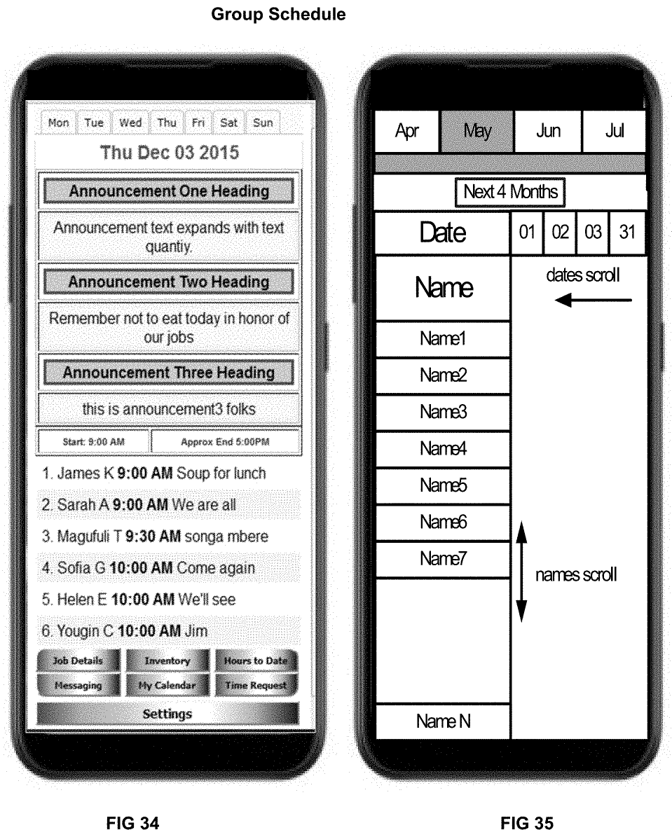

FIG. 32: The user interface of FIG. 34 with a user's name on top, displays individual schedule one month at a time. However, three or four months are showed on the top menu for the user to choose a month of interest. Any month selected from the top menu displays schedule data corresponding to that month and dates. If a month contains 31 days, the interface displays up to 31 days. If on the other hand a month is February and goes up to 28 or 29 days, the interface utilizes the date function to read the last date and shows it.

The schedule app starts by displaying date and then day of the week but the two are interchangeable. It then displays the start time and approximate end time. The current date is always highlighted as the case for May 4^{th} Wednesday above. A year, not shown, is displayed next to the user's name on top.

The schedule App displays individual schedules showing a default month and other month tabs, date, day of the week, start time and end time of an individual. The user scrolls to view all scheduled days in a month.

All user interfaces in this application are configurable to show a previous month as part of the four months.

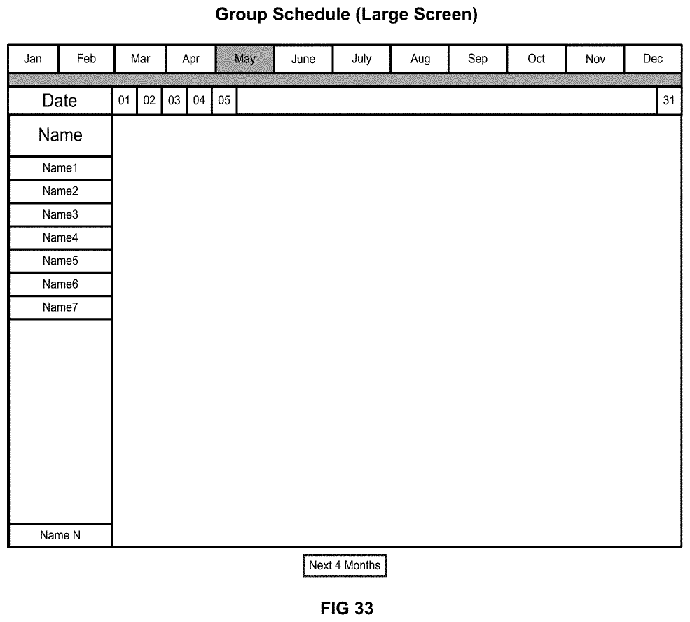

FIG. 33 The user interface of FIG. 33 displays a group schedule on a monthly basis on a large screen such as that of a computer. If a company schedule comes out every two weeks, the panel only displays two weeks of dates. The other dates don't show up. They are automatically hidden by the software.

Similarly, the month buttons on the top menu displays only four or three months at a time based on user configuration. The user configures to display 3 or 4 months at a time. A button is placed at the bottom of the screen to press for the next four months in a sequence. This allows the screen to display with a reasonable size on all screen size devices.

To use this interface, a user touches the month button of the month they are interested in to open it. However, the current month is highlighted by default and it is the one that displays the names when a user presses or selects to view a group schedule. As seen currently, all the names scheduled for the current month starting with the current day displays on the screen with dates increasing in a horizontal direction.

When a user touches the actual date in the selected month, only the users scheduled for that date displays. When the user on the other hand touches one of the names, they get to see the individual start and end times on the selected day.

If the user's screen happens to be small such that they can't view the entire screen as in the case of mobile phones, the user can scroll the schedule towards the side of the names (to the left) to view more dates on the right side. The frame on which the names are doesn't scroll left or right but down and up. This allows the schedule to move under the names as it is scrolled to the left. The names align with the date intersection.

FIG. 34 displays a weekly group schedule and daily schedules.

If a company posts schedules longer than 7 days, the user gets a schedule similar to that of FIG. 35 which covers up to a year. The scheduler App in this system displays individual schedules showing a default month and other month tabs, date, day of the week, start time and end time of an individual wherein the user scrolls to view all scheduled days in a month.

FIG. 35 displays three to four months at a time but defaults to the current month. The user presses a Month tab to display a corresponding month.

The system displays schedules longer than seven days by providing month tabs that a user touches to display corresponding dates and days with scrollable names and buttons to show next or previous months. A display on the mobile app shows a few months at a time.

A button labeled Next 4 Months displays the next group of 3 months plus one of the previous months for history.

The dates are displayed across and they scroll in a left-right manner. The names on the other hand are displayed vertically and they scroll up and down to match the dates. Intersections of dates and names show where an employee is on or off.

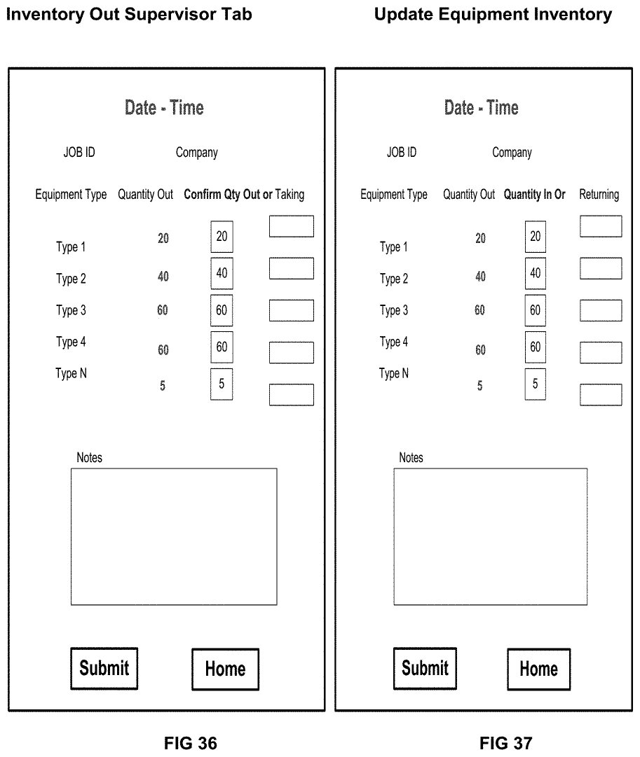

FIG. 36: The user interface of FIG. 36 is utilized by employees taking inventory out of a warehouse, storage or any other place. The type and quantity of whatever they are taking is prefilled by the application from the database. It is entered by someone else preferably the one that schedules the projects to be worked on. We see three columns namely quantity out which specifies the quantity the person intended for the project. The second column labeled confirm Qty, is made of buttons prefilled with the same quantities like in the first column. The user just presses a button to accept that they are taking that amount. If they are taking different quantity other than what is specified, they manually type it in the third column. If the user accidentally confirms the number provided, it is the warehouse personnel that corrects it as a security measure. The inventory in this case refers to anything that is countable including equipment, medicine and food. Data is prefilled in buttons for quick data entry and prevention of data entry errors. Employees can download the inventory to local storage on their device. The local storage can be a mini database, browser storage or other. Data is synchronized upon server connection.

FIG. 37: The user interface of FIG. 39 is utilized to reconcile equipment inventory upon return. If quantity in is less than quantity out, that info is entered in the black text field labeled “Returning”. A text area is also provided for notes or comments.

The image or picture module enables users to take photos of things and upload them to the server from where they are accessed by authorized users. These images may be photos of buildings or any items of interest.

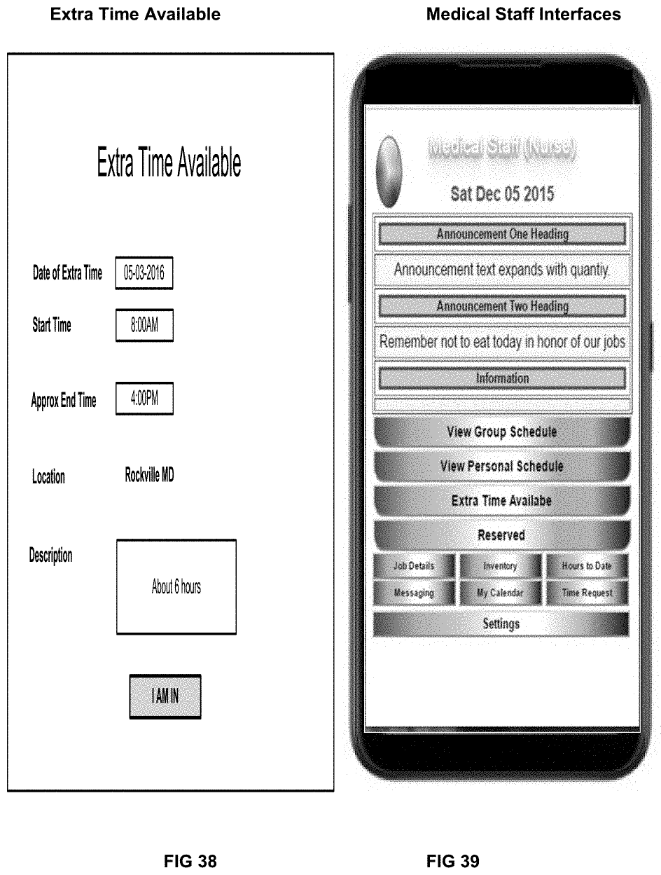

FIG. 38: The user interface of FIG. 38 is obtained when a user opens the Extra Time Available link from the main menu. Upon pressing I am In, they register to accept to work extra time.

The system provides extra time as an announcement button link that a user opens to display date of extra time, start time, approximate end time or number of hours, location of extra time and description of the assignment wherein the user touches a button links to indicate they are interested.

FIG. 39: The UI of FIG. 39 is utilized by medical workers. The Job Detail button from the medical module of the application FIG. 39 is subdivided into three sections namely Case Load, Case Details and Settings. However, the information contained in this footer button is alternatively placed on one of the main buttons of the application.

Patients' records are identified by record ID to prevent unauthorized personnel from identifying the patients. The medical worker compares the number referred to as patient record ID to the one on the bed or patient arm to identify the patient.

If the worker's device is equipped with a barcode or QR Code scanner, the worker's device scans the code on the patient's arm or bed to assist with identification and data entry. When a code is scanned, the patient's record pops up on the worker's device. The scanning feature also prevents misidentification of a patient if the medical worker happens to be tired or absent minded and they can't read the tag on the arm.

This software application works on all devices with an operating system.

The link labeled inventory in the medical application is utilized to track medical related inventory which includes drugs and all the accessories used. A special database is setup to inventory many different kinds of drugs if needed.

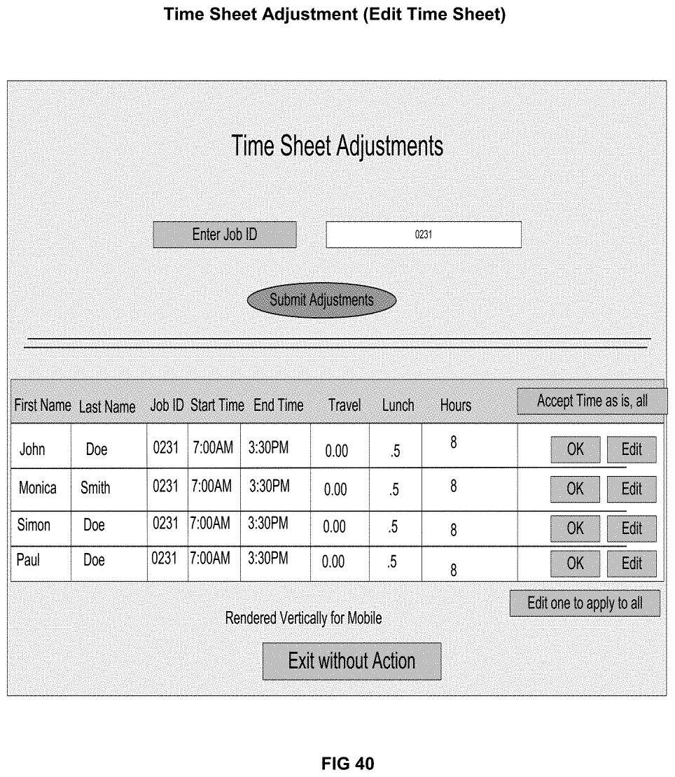

FIG. 40: The user interface of FIG. 40 is used to edit time sheet when something is not right. Changes could be subtracting unpaid lunch time or changing the actual start or end time. The button Accept times as is all, saves the data in a button click and Edit one to apply to all edits once for all employees.

FIG. 41 records day end time sheet. Though a user may enter a job ID in the user interface of FIG. 41, the application software system recognizes the user logon and fetches the current job automatically. An option is provided to switch to a different job. The user only presses OK to confirm the times or Edit to make changes to each of the employees involved. To accept all times at once, the user presses the button on top that says Accept Time as is, all. To edit all at once, the user edits one employee and presses the Edit one to apply to all button.

FIG. 42: When a user selects View Individual Schedule from the user interface of FIG. 31, they get a user interface similar to that of FIGS. 34 and 35 depending on their screen size. The interface of FIG. 35 displays all the 12 months in a year and can display only three or four months when configured to do so. It displays each day of the week and corresponding start and end times for each day.

On the left side, it shows the actual dates in that month. On the top menu, it displays days of the week, start time and corresponding end time for each day of the week.

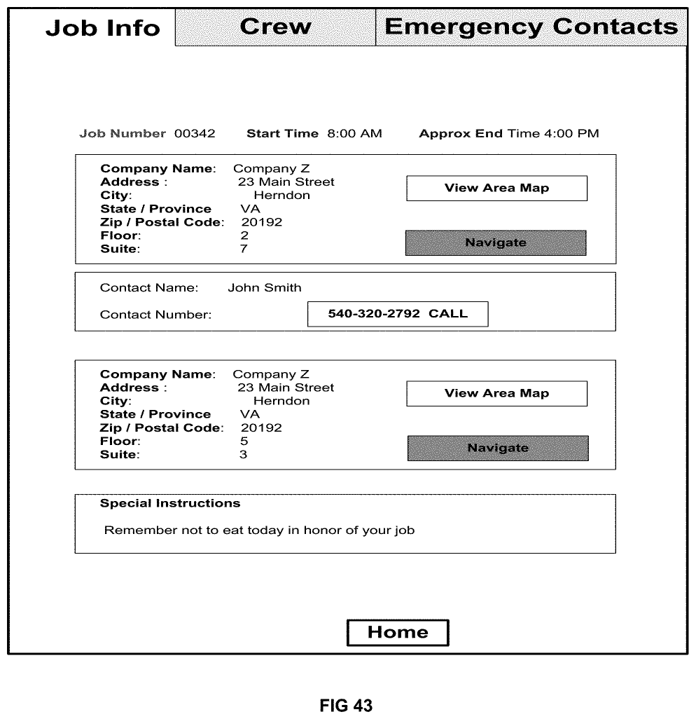

FIG. 43: The Job Info tab in the user interface of FIG. 43 displays information required to perform the current job. If necessary, contact email may also be included. It displays the job number, start time and approximate end time, company name and the addresses involved including the floor and suite. It also provides area map and navigation from one address to another if travel is involved. The contact person for the job and their phone number are provided as seen in the UI. If there are any special instructions relevant to the job, the instructions are entered to the server and retrieved by the mobile app. This feature is particularly useful for moving companies and restaurants.

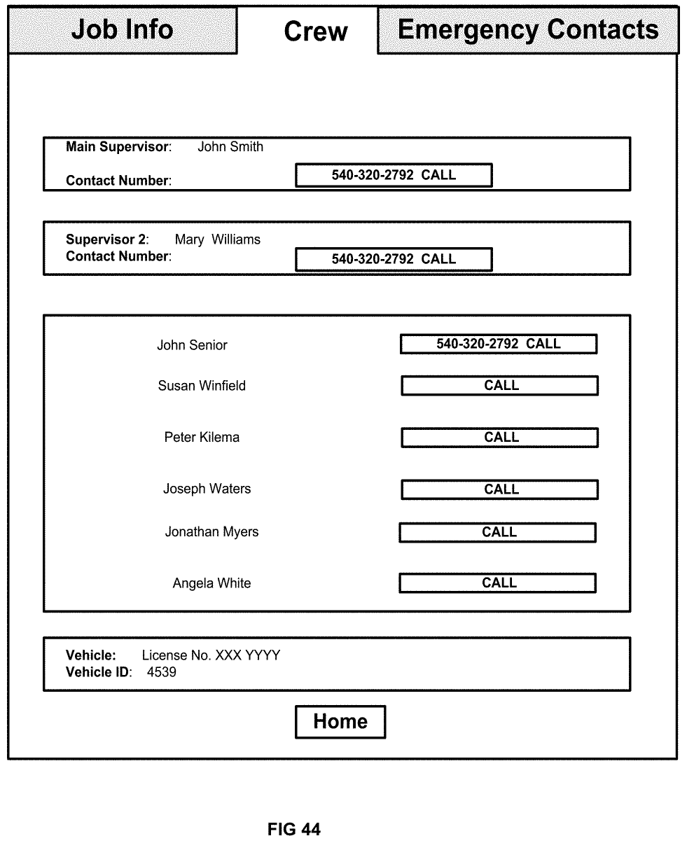

FIG. 44: The tab labeled Crew provides contact numbers of coworkers on a specific project or job including supervisors. The actual numbers may display or may not display basing on company policy.

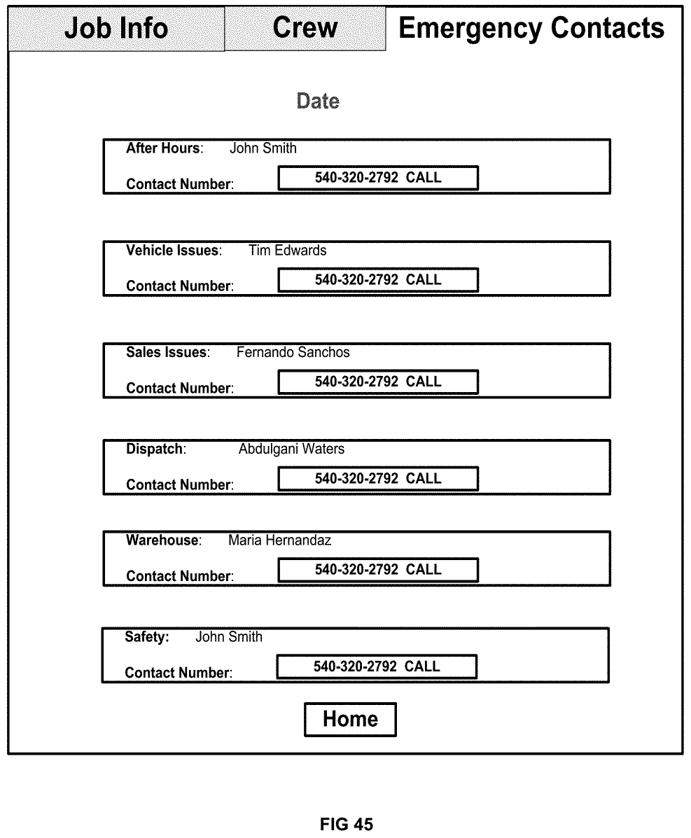

FIG. 45: The Emergency tab of FIG. 45 displays vital contacts related to the job in progress. One may view a number and type it in their phone to call or press a call button and call directly from the application.

The user interfaces used for inventory are skipped here because they are described under the supervisor menu. The tab labeled Messaging refers to a separate application that is linked to and so the user interface for that is not displayed either.

My Calendar is a separate application that works independently. It is only linked to from this application to write employee time off and read other availability information. That application owner authorizes this application prior to access.

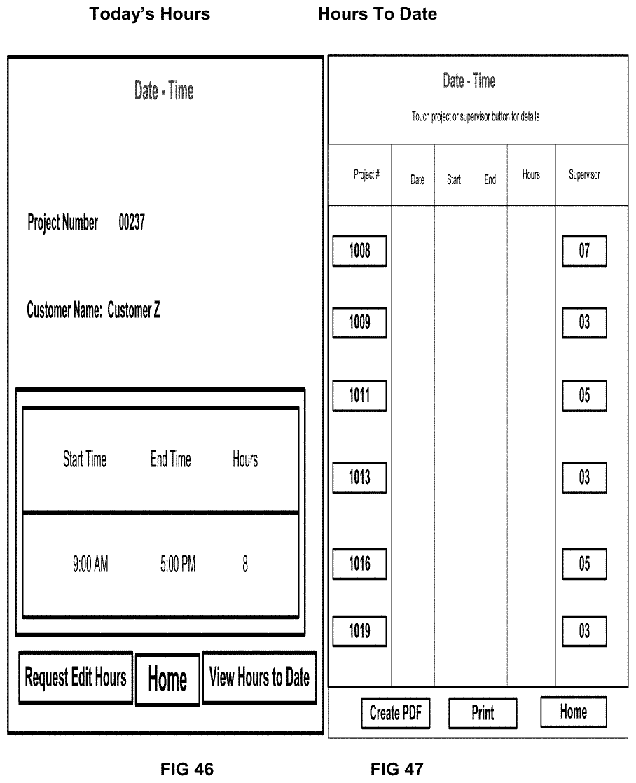

FIG. 46: The user interface shows the project or job number and customer company name.

If one is scheduled and they are on a job or they have finished a job, they can see current hours as displayed in the user interface of FIG. 46. If they are not scheduled that day or it is not yet end of day and hours are not in, they get the hours to date user interface when they press the View Hours to Date button.

When an employee reads the hours and happens not to agree with what they see, the employee presses the Request Edit Hours button link to file a complaint to the supervisor so he/she can change the hours accordingly. The home button takes the user to the main menu and the Hours to Date button link displays the accumulated hours for the period of interest say two weeks, a month etc.

The user interface of FIG. 47 represents the Hours to Date user interface generated to show employees their accumulated hours for a specific period of time such as a week or month. It scrolls upwards to display more data when a user touches the UI. As displayed, it shows a project or job number, date of execution, start time and end time, number of hours for that day and supervisor ID. To display details for each job, the user touches the project number or supervisor number.

In one implementation, either project number or supervisor number is removed to allow for a better display of the rest of the columns. To see details, the user touches the remaining button (project number or supervisor number) and they see the job details. The main purpose is to show accumulated hours over a period of time. The user can generate a pdf file from the hours and save it somewhere else for reference.

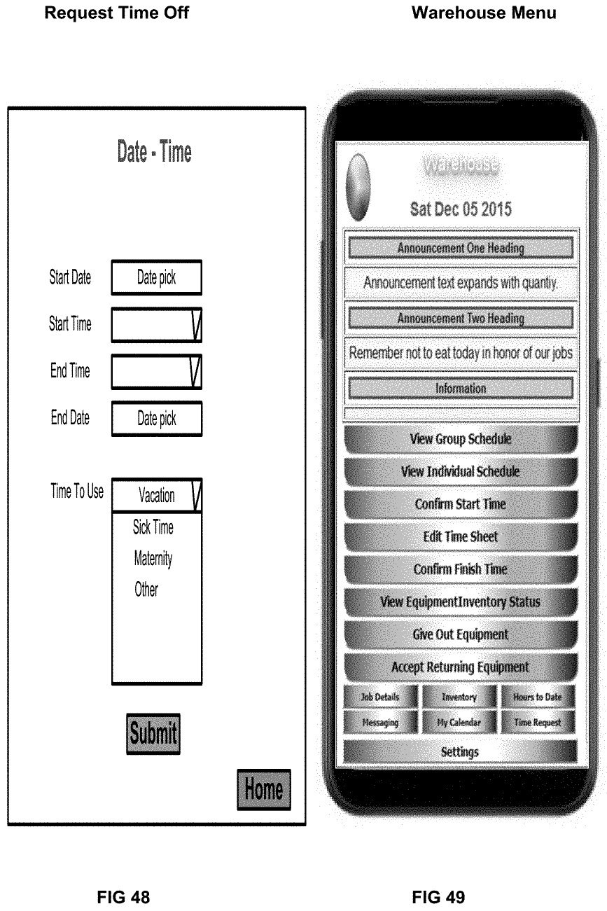

FIG. 48: The user interface of FIG. 48 is utilized to request time off. Employee name and date of submission are automatically read from the application logon and entered into the database or file to prevent excessive data entry. Once a user logs on, she is recognized by the system software. The user only enters the start date of the leave, start time, of that day, end date, end time of the end date and type of leave requested. The software calculates the number of hours requested and displays them to the requester. An algorithm displays this process. The algorithm also reads the number of hours the user has accumulated and compares. If the user happens to have enough hours, the request is submitted for approval or denial. If they don't have enough hours accumulated, they are informed to make adjustments and resubmit.

The supervisor or manager utilizes a slightly different user interface with a radio button for approval and another for denial. The interface also has a text area where the manager enters reason for not approving and comments. The date and time the manager approves or denies is automatically read and entered by the application.

The application enters approvals to the employee's work calendar.

The settings button opens a settings user interface. The settings UI allow users to configure appearance of their displays, change password and more.

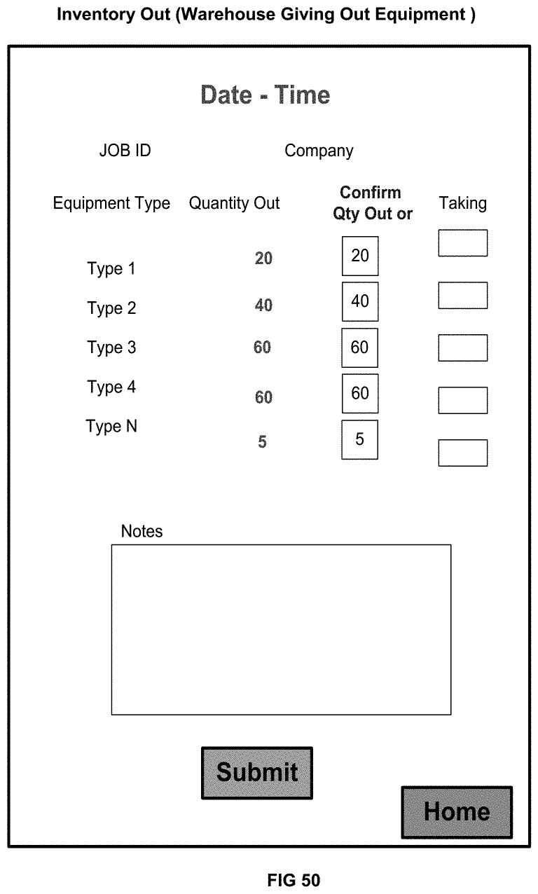

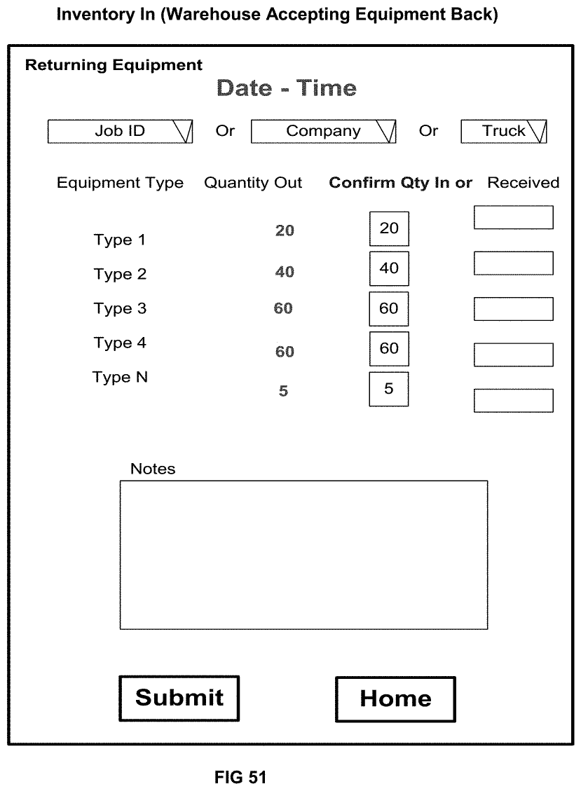

FIG. 49: The user interface of FIG. 49 displays the main menu of a warehouse supervisor or employee. The three button links that are not yet explained are View Equipment Inventory Status which displays a list of all projects that are either active or were executed that day and corresponding status of equipment that was taken out or brought back in. The Give Out Equipment button link provides a user interface (FIG. 50) that allows a warehouse person to give out equipment to field employees and record the inventory without much effort. Accept Returning Equipment (FIG. 51) provides a UI that records returning inventory.

FIG. 50: The User Interface of FIG. 50 shows inventory out. That is, a warehouse or store gives out to field workers and records transaction data. Inventory could be equipment, medicine or other. The number of equipment type that displays depends on how many different types of equipments were assigned to the job when setting up the project. The quantity out showed in red is read from a database and displayed in that location or anywhere suitable. It is added to the database when office users assign equipment to projects. The same quantity is displayed in buttons or other web features that one can just press to confirm the number without typing anything that could introduce data entry errors. These buttons or other are placed in a column named Confirm Qty. Upon pressing the button, the quantity returned or taken out is confirmed. If a different quantity other than what is displayed is being taken, the user touches the empty text box and types the actual quantity being taken. During implementation, the words are structured to fit on small screens.

FIG. 51: The user interface of FIG. 51 is used by the warehouse or store personnel to record returning equipment into the inventory database. Buttons filled with data from the database are used to do data entry in order to minimize data entry errors. Alternatively, selection menus are utilized.

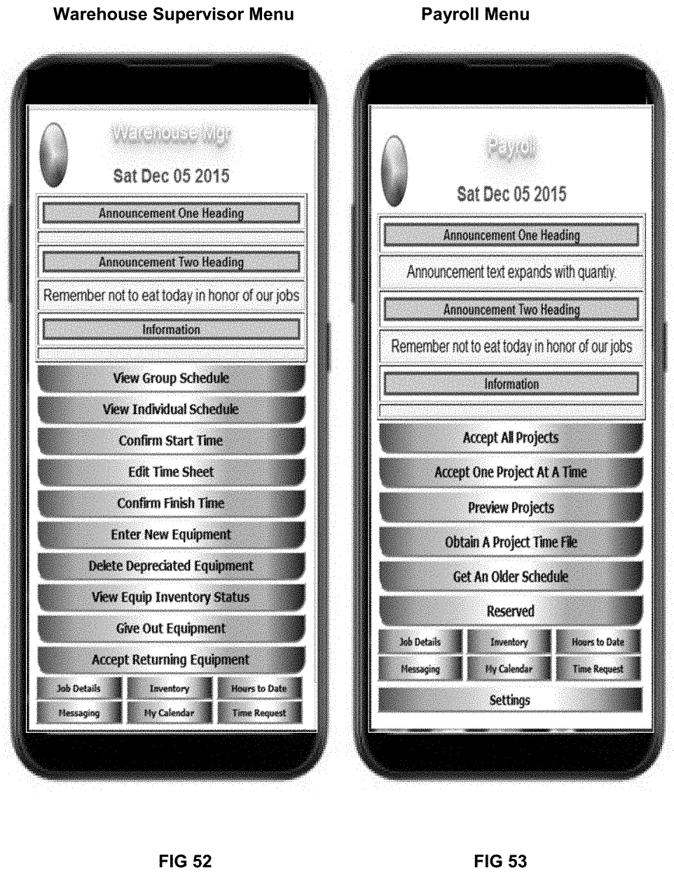

FIG. 52: The warehouse supervisor or manager menu differs from the warehouse menu in that it provides for interfaces through extra buttons as named below. Enter New Equipment which allows the supervisor to enter newly acquired inventory. Delete Depreciated Equipment refers to discontinued equipment that is no longer needed. Deleting equipment from company accounts for checks and balances. People that enter new equipment may not be the ones that delete deprecated equipment to prevent not entering equipment. View Equip Inventory Status enables the supervisor to see what jobs or inventory needs to be taken care of. These features are utilized across all other industries that this application applies to.

FIG. 53: The user interface of FIG. 53 allows the payroll department to control the hours from the field manually instead of automating the time transfer from database to database. Payroll can accept all projects at once, accept one project at a time, preview projects, obtain a project or hours of from a job by downloading a file. At any given time, they can get hours from an old schedule when they specify the date or date range. They can also read old schedules for reference.

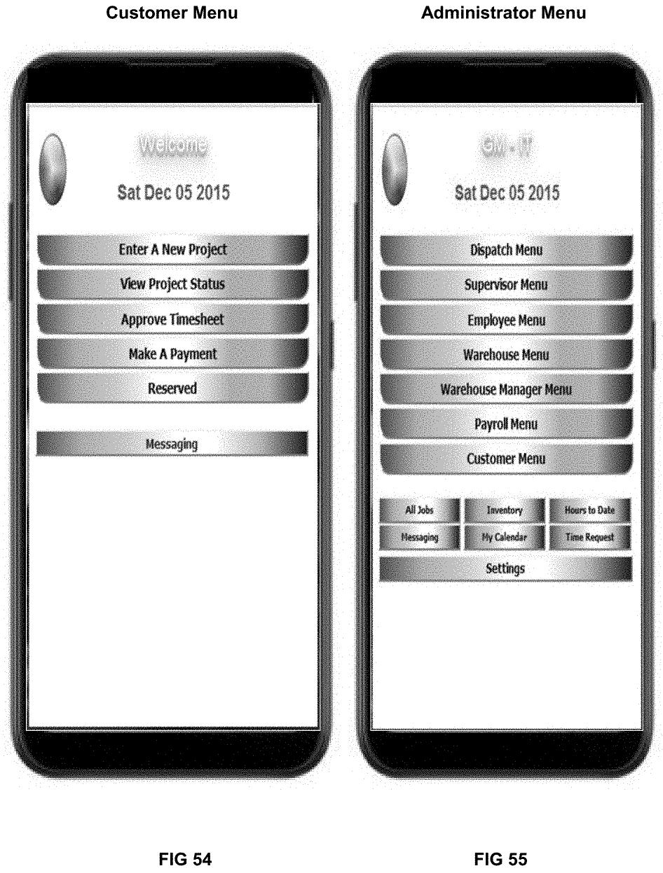

The interface of FIG. 54 is utilized by external clients that avails projects to the employer for execution. They have options to enter new projects, view project status, approve time sheets at the end of the day and make payments.

The make a payment option displays a payment user interface that links to a payment system.

The reserved button link space connects to a customer specific application such as the Move Tool for moving clients. The clients can follow through the stages of an executing move job and advise whenever necessary as explained in the Move Tool. The footer button links are not showed but will be added during development to allow the client to utilize applications such as the messaging and calendar.

FIG. 55: The administrator menu is primarily a view of the entire application menu by menu. The users of this menu of whom might be the general manager and the IT department gets access to all the other user interfaces in one menu.

Medical Specific Algorithms and User Interfaces

FIG. 56: The settings tab in the medical user interface of FIG. 56 provides a user interface that allows medical workers to set how they want their App to remind them of the cases they have. One can set sound reminder, vibrate reminder or both. They set frequency of alerts and how long before the actual time they are alerted. The last reminder gives them the minimum time they can get to the patient and attend to them in a timely manner.

FIG. 57: The UI of FIG. 52 is utilized by medical supervisors to carry out functions as listed on the menu. Most of the button links are described under the dispatch manager. The Download Patient Activity button FIG. 62, is pressed to download data from the servers that run this application to servers that serves a hospital or other medical establishment. When the button is pressed, the application extracts data from the application's database into comma delimited files or .csv files or data structures such as arrays. Data is then read from these and uploaded to database tables from where it can be analyzed. However, the process of data transfer is automated so this button link may rarely be utilized.

This application was designed with hippa laws under consideration so no patient identifying information is passed through public networks since personal mobile devices are involved. Patients are identified by their patient ID number.

Our preference is not to identify anyone by name. Initials may be used to represent medical workers in addition to their user id and passwords. Whether medical workers are identified by their user names and emails or actual names depends on their facility policy.

When equipped with a barcode or QR Code scanner, a medical worker may get to the patient, open the application and scan the band on the patient or patient's bed. This pulls information of the patient from the mobile device and displays it on the screen. That prevents a medical worker from matching a patient to a wrong id number.

If a client wants to run statistical analysis on the data with real patient names, they utilize the Download Activity button to get data to a server that can access a database with patient names. Alternatively, the software is automatically configured to download that data without human intervention. It depends on client's interest. We customize.

Identification of devices that access the application and databases are recorded for security purposes. Identifications may include IP address of the mobile devices or MAC address and utilized as part of the authentication process.

In summary, data is either posted to the client's server and uploaded by triggers to the receiving server or data is posted to the receiving server and downloaded to the client's accessible machine. This guarantees data availability regardless of network connectivity.

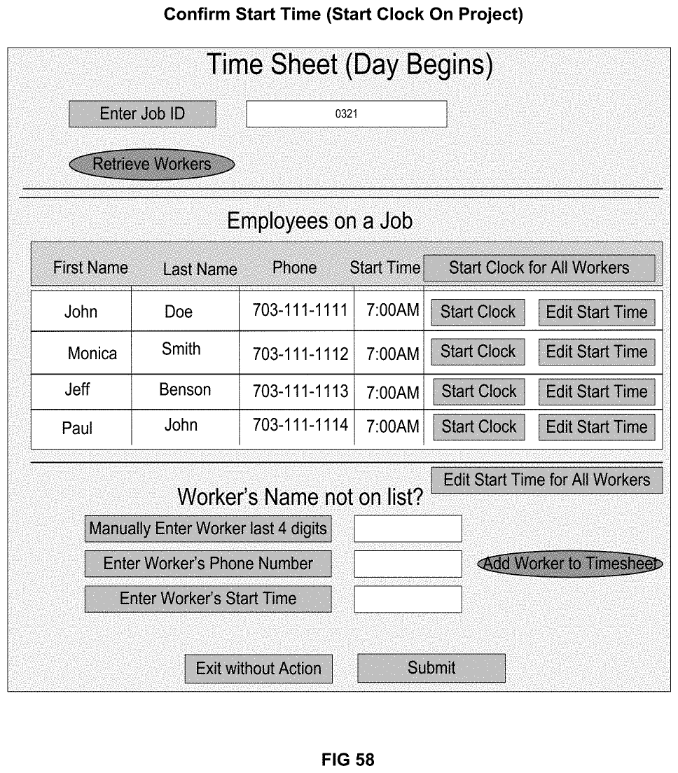

FIG. 58 The user interface of FIG. 58 is obtained when a supervisor selects Confirm Start Time on the menu options. It provides employees on a specific job and the time they are scheduled to start work. The start Clock button confirms the pre-filled start time. To change to a different start time, the supervisor selects the Edit Start Time button. Start Clock for All Workers saves time by recording all at once. Similarly, Edit Start Time For All Workers changes time to the same new time.

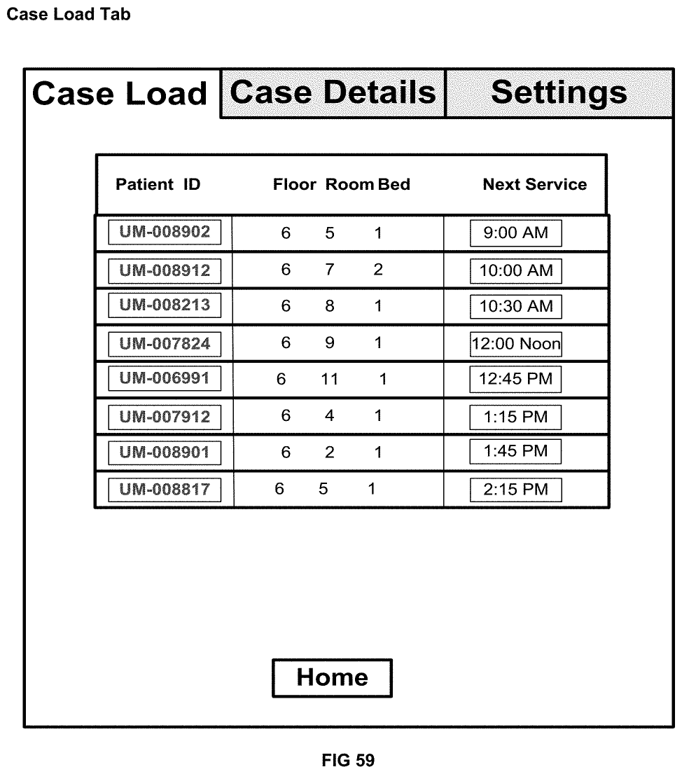

FIG. 59: The UI of FIG. 59 is utilized by medical workers to obtain patient records and record their job activities based on schedules. The Case Load tab is the default display that a medical worker gets when they press Job Details. It displays the medical worker's case load in summary form showing patient ID, floor, room number and bed number where the patients are located and next time they each need service. When the medical worker touches the patient id, they get details about that patient.

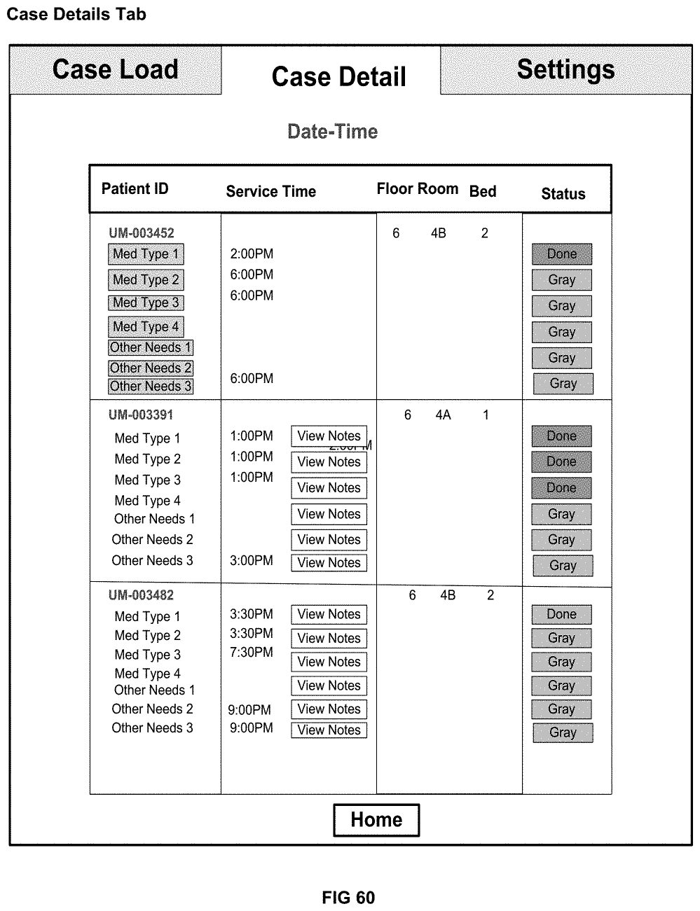

FIG. 60: The Case Details tab provides detailed information about each patient. It is here that data entry is done only by pressing buttons. No typing is involved to prevent data entry errors. When a medical worker is finished with an item of service, they press the button next to that service and the button toggles to indicate a status of done with a bright color such as light green.

A button is provided along side each required service to view details of the service in case the medical worker is not familiar with the patient. However, this button is alternatively placed at the button of each patient's record to show all that need to be seen from one button. This conserves space on the device screen. When the worker presses a button to indicate that the assignment is completed (service provided), the button changes color from grey to a bright color such as green.

In another implementation, each service need is a button itself. This is exemplified under patient ID UM-003452 where med Type1, med Type2, medType3 and med Type4 and other Needs are presented as buttons. To view details of a needed service, the medical worker only presses the button for the needed service and views the details in a new pop up window which closes to return to where the worker was. This implementation eliminates the View Notes buttons seen under the other patients. It frees up a column space to make it more mobile friendly.

If a prescription needed at 2:00 PM is named Med Type 1, that name will be a button reading Med Type 1. The worker just presses that button to view details of the drug and frequency. The workers are reminded by alerts that they set on their devices. These alerts can be sound, vibrate or both.

What is claimed:

1. A Scheduling system that provides daily, weekly, monthly and annual worker schedules via a Mobile App accessible by authentication comprising:
a prulility of algorithms executed by a prulility of user interfaces that interact with a database system or file system via graphical user interfaces to generate schedules for medical workers, movers, restaurants, food workers and other industries by customization.

2. The scheduler in the system of claim 1 utilizes real time distributed data entry to automatically generate schedules.

3. Employees request for time off via a mobile app in the system of claim 2 and sends requests directly into a time management software system from which supervisors approve or deny the requests.

4. The Scheduling System of claim 2 reads worker availability, accumulated time and skills records to automate the scheduling wherein schedules are visible in installable mobile app without human intervention.

5. The Secure Scheduling System of claim 4 specializes in fluctuating schedules wherein instantaneous changes on a schedule are reflected on the user's mobile device in real time.

6. The Secure Scheduling System of claim 3 provides dispatchers with touch or click options to display employee schedules for single employee, by project, by supervisor, by department or all employees at once.

7. Said system of claim 6 provides employers with settings options to restrict workers from viewing any other person's schedule besides their own.

8. The Secure Scheduling System of claim 1, provides a display for medical workers, movers and food workers to view ads in form of text, audio and video.

9. Said mobile app in the scheduler system of claim 1 displays ads in form of videos, text or audio in a designated window separate from other content for custom industries that include factory, warehouses and retail.

10. The scheduler system of claim 7 provides a means for displaying available overtime to workers on the mobile app as an announcement button link that a user opens to display date of extra time, start time, approximate end time or number of hours, location of extra time and description of the assignment wherein, workers respond to accept the overtime through the mobile app.

11. The installable mobile app in the system of claim 10 displays a listing of workers with their names, current hours to date, name formatting options including a highlighter, bold and italicize for emphasis wherein a schedule button, checkbox or radio button is utilized to schedule an individual or group.

12. The system of claim 4 provides a user interface from which the schedule is styled and displayed based on name format, shift display, time display or length of schedule wherein checkboxes, radio buttons and dropdown menus are utilized to accomplish the tasks.

13. The system of claim 4 displays schedules longer than seven days by providing month tabs that a user touches to display corresponding dates and days with scrollable names and buttons to show next or previous months wherein a display on the mobile app shows a few months at a time

14. The scheduler App in the system of claim 13 displays individual schedules showing a default month and other month tabs, date, day of the week, start time and end time of an individual wherein the user scrolls to view all scheduled days in a month.

15. The system of claim 7 performs automated scheduling based on, conditions provided on each of the employees, how many hours they have accumulated to date, their skills and job required skills wherein hours to date are accessible via a button link in the mobile app;

16. The scheduler in the system of claim 14 sends alerts to workers when there is a change in the schedule; and
compares number of hours worked to date to the maximum number of hours any employee can work a week to ensure they don't exceed the maximum.

17. The system of claim 12 provides access to second and third party clients to enter work projects providing parameters that include number of employees required for a job, required skills, start date, start time, end time, job duration and ads in form of text, audio or video wherein the parameters are utilized during auto worker scheduling to display the contents in the mobile app.

18. A method of scheduling employees in a system where information in the employee's availability calendar and conditions is utilized to schedule them for a project or routine work.

19. The method in the system of claim 18, assigns a vehicle and equipment to a job to which workers are assigned wherein the equipment and vehicle assigned to their job becomes visible to the workers through the mobile app.

20. Hours worked for every project in the system of claim 18 are automatically uploaded to the payroll records when the supervisor approves them from the mobile app or browser based app saving hours of data entry to the server.
